(19) United States
(12) Patent Application Publication
(10) Pub. No.: US 2025/0001947 A1
(43) Pub. Date: Jan. 2, 2025

(54) COMPONENT FOR VEHICLE INTERIOR

(71) Applicant: Yanfeng International Automotive Technology Co., Ltd., Novi, MI (US)

(72) Inventors: Michael Robert Catlin, Holland, MI (US); Michael Whitlock, Lowell, MI (US); Bradley Bartyzel, Washington Township, MI (US)

(21) Appl. No.: 18/757,444

(22) Filed: Jun. 27, 2024

Related U.S. Application Data
(60) Provisional application No. 63/523,915, filed on Jun. 28, 2023.

(51) Int. Cl. B60R 7/08

(52) U.S. Cl. CPC B60R 7/08

(57) ABSTRACT

A component for a system for containing/interchange of data on an article for a compartment in an interior of a vehicle is disclosed. The component for a vehicle interior may comprise a housing comprising a compartment for an article such as a key card or key fob; the component may retain a key card; the component may be shipped with the key fob and/or key card and installed into the vehicle interior as a unit. The component may comprise a feature to retain the key card; the retention feature may provide a gap through which the key card may slide for installation to the housing. The key card may cover the compartment; the component may provide a label/data interface for interaction and/or connection (e.g. with a code scanner, mobile device camera, etc.). The component may be installed, press-fit and/or a snap-fit in a subassembly (e.g. a cup holder, floor/center console, door, cockpit, or an instrument panel). The subassembly may comprise a module for the key fob and/or key card. Vehicle data to be associated with the article/vehicle may be interchanged/transmitted on data/network systems including for data security/security, data interchange, communications with devices such as network devices and mobile devices (e.g. to provide key/access capability for the vehicle), data interchange devices to facilitate interchange of data to a mobile device or other devices, etc. operating with a computing system, data storage, etc.

### CROSS-REFERENCE TO RELATED APPLICATIONS

The present application claims priority to and incorporates by reference in full the following patent application: U.S. Provisional Patent Application No. 63/523,915 titled “COMPONENT FOR VEHICLE INTERIOR” filed Jun. 28, 2023.

### FIELD

The present invention relates to a component for a vehicle interior.

### BACKGROUND

It is known to provide a key fob and/or a key card for a vehicle.

It would be advantageous to provide a component comprising a compartment configured to receive a data-containing article such as a key fob and/or a key card for a vehicle.

### SUMMARY

The present invention relates to a component for an interior of a vehicle configured to contain an article containing data for the vehicle comprising a housing comprising a compartment. The compartment may be configured to contain the article. The component may comprise a feature configured to retain the article in the housing. The article may comprise at least one of (a) a key, (b) an electronic key unit, (c) a card, (d) a card containing data, (e) a key card, (f) a fob, (g) a key fob, (h) a label, (i) a tag, (j) a data tag, (k) and electronic tag, (l) a detectable tag, (m) a scannable tag, (n) a scannable label, (o) a code, (p) a readable code, (q) a tag configured for data interchange with a data interchange device, (r) a tag configured for data interchange to a computing device, (s) a tag configured for data interchange to a mobile device. The feature may be configured to provide a receptacle for a key card; so that the key card may be configured to be retained in the housing. The feature may comprise a retention feature comprising a L-shaped tab provided on the housing. The feature may be configured to provide a slot for a key card; the slot may comprise a gap; the key card may be configured to be inserted into the gap of the slot for installation in the housing. The feature may be configured to clamp a key card to the housing. The article may comprise a key card; the key card may be configured to provide a cover for the housing; the key card can be moved between a position to cover the compartment and a position to uncover the compartment. The housing may comprise a projection. The projection may comprise a tab; the tab may comprise a label; the label may be configured to comprise data and/or information. The projection may comprise a tab; the tab may comprise a hole configured for a ring. The housing may comprise an attachment feature configured to retain the housing in the interior of the vehicle; the attachment feature may comprise a projection. The component may comprise a subassembly comprising the housing; the subassembly may be configured for installation in the interior of the vehicle. The housing may be configured for installation in the subassembly by at least one of press-fit assembly and/or snap-fit assembly. The subassembly may comprise at least one of (a) a cup holder, (b) a floor console, (c) a center console, (d) a door, (e) a cockpit, (f) an instrument panel, (g) a module for the article within the compartment. The article containing data may be configured for electronic data interchange and/or wireless data interchange. The article containing data may be configured for data interchange with a data interchange device. The article containing data may comprise a tag containing data; data from the tag may be configured for data interchange; the tag may comprise at least one of (a) an electronic tag configured for electronic/wireless data interchange and/or (b) a label configured to be detected by a data interchange device. The tag may comprise an electronic tag for the article and/or a label on the article.

The present invention relates to a method of providing interchange of data for a vehicle with a component for an interior of the vehicle configured to contain an article containing data for the vehicle comprising the steps of providing a compartment for the article in the interior of the vehicle, providing the article with data relating to the vehicle, associating the article with the vehicle by data interchange, and transporting the article for the vehicle. Transporting the article may comprise at least one of (a) transporting the article in the compartment of the vehicle or (b) transporting the article with the vehicle or (c) transporting the article separately from the vehicle or (d) transporting the article separately from the compartment. The article may comprise at least one of (a) a key, (b) an electronic key unit, (c) a card, (d) a card containing data, (e) a key card, (f) a fob, (g) a key fob, (h) a label, (i) a tag, (j) a data tag, (k) and electronic tag, (l) a detectable tag, (m) a scannable tag, (n) a scannable label, (o) a code, (p) a readable code, (q) a tag configured for data interchange with a data interchange device, (r) a tag configured for data interchange to a computing device, (s) a tag configured for data interchange to a mobile device, (t) a tag configured to provide a data interface. Data may comprise at least one of (a) vehicle data, (b) vehicle identification data, (c) vehicle identification number (VIN), (d) security data, (e) vehicle access data, (f) vehicle access data, (g) vehicle key data, (h) a bar code, (i) a QR code, (j) a tag, (k) an RFID tag, (l) a data tag, (m) scannable data, (n) visual data, (o) electronic data. Data interchange may comprise at least one of (a) data interchange for the vehicle, (b) data interchange for access to the vehicle, (c) data interchange for operation of the vehicle (d) data interchange for transmission to the vehicle, (e) data interchange for transmission from the vehicle, (f) associating the article for the vehicle, (g) associating a key unit with the vehicle, (h) associating a key fob with the vehicle, (i) tracking, (j) matching, (k) monitoring, (l) authenticating, (m) identification, (n) serialization, (o) communication, and/or (p) an instruction.

The present invention relates to a component for use by an occupant in an interior of a vehicle comprising a housing comprising a compartment. The compartment may be configured to receive a key fob for the vehicle. The component may be configured to be shipped together with the key fob and installed into the vehicle interior as a unit. The component may be configured to be removed by the occupant after installation into the vehicle interior. The component may be configured to be installed in the interior of the vehicle. The component may be removed from the interior of the vehicle for use by the occupant outside of the vehicle. The component may comprise a retention feature configured to retain the key fob. The component may be configured to retain a key card for the vehicle. The component may be configured to be shipped together with the key card and installed into the vehicle interior as a unit. The component may be configured to be removed by the occupant after installation into the vehicle interior. The component may comprise a retention feature configured to retain the key card. The retention feature may comprise an “L” shaped tab. The retention feature may comprise a set of tabs. The retention feature may comprise a set of tabs extending above the compartment. The retention feature may be configured to provide a gap through which the key card may slide for installation of the key card to the housing. The retention feature may be configured to clamp the key card to the housing. The key card may be configured to cover the compartment. The key card may comprise a lid for the compartment. The key card may be configured to move between a closed position to cover the compartment and an open position to uncover the compartment. The key card may be configured to open, lock and or start the vehicle. The housing may comprise a tab. The tab may comprise a label. The component may comprise a hole configured for a ring. The component may comprise a tab comprising the hole. The component may provide a data interface. The data interface may be configured for interaction and/or connection with a scanner. The component may comprise a label comprising data or information. The component may comprise a label comprising at least one of (a) a vehicle identification number; (b) a bar code; (c) a QR code, (d) a tag, (e) an RFID tag, (f) a data tag, (g) a transmitter. The component may comprise a label configured for at least one of (a) serializing the key fob to the vehicle; (b) tracking; (c) matching; (d) monitoring; (e) authenticating; (f) identification; (g) serialization; (h) communication; and/or (i) an instruction. The component may comprise a label; use by an occupant may comprise scanning the label. The housing may comprise an attachment feature configured to retain the housing in the interior of the vehicle. The attachment feature may comprise a protrusion extending away from the compartment. The component may be configured for installation in a subassembly for the vehicle interior. The subassembly for the vehicle interior may comprise at least one of (a) a cup holder; (b) a floor console; (c) a center console; (d) a door; (e) a cockpit; (f) an instrument panel. The component may be configured for at least one of a press-fit assembly to the subassembly and/or a snap-fit assembly to the subassembly. A subassembly for a vehicle interior may comprise the component. The subassembly may comprise a module for the key fob and/or a key card. The key fob may be configured to open, lock and or start the vehicle. The key fob may comprise a set of key fobs.

The present invention relates to a method of installing a key in a vehicle interior comprising the steps of installing the key in a component and installing the component in a subassembly for the vehicle interior. The key may comprise at least one of a key fob and/or a key card. The method may comprise the step of installing a module for the key to the subassembly for the vehicle interior. The method may comprise the step of scanning the module. The step of scanning the module may comprise at least one of (a) serializing the module to the vehicle; (b) tracking; (c) matching; (d) monitoring; (e) authenticating; (f) identification; (g) serialization; (h) communication; and/or (i) an instruction. The method may comprise the step of installing the subassembly for the vehicle interior in the vehicle interior. The component may comprise a housing comprising a compartment. The step of installing the key in a component may comprise placing the key in the compartment. The step of installing the key in a component may comprise snapping and/or pressing a key fob into the component. The step of installing the key in a component may comprise sliding a key card onto the component to provide a lid for a compartment. The component may comprise a label. The method may comprise the step of scanning the label. The step of scanning the label may comprise at least one of (a) serializing the key to the vehicle; (b) tracking; (c) matching; (d) monitoring; (e) authenticating; (f) identification; (g) serialization; (h) communication; and/or (i) an instruction. The label may comprise at least one of (a) a vehicle identification number, (b) a bar code, (c) a QR code, (d) a tag, (e) an RFID tag, (f) a data tag, (g) a transmitter. The subassembly for the vehicle interior may comprise at least one of (a) a cup holder; (b) a floor console; (c) a center console; (d) a door; (e) a cockpit; (f) an instrument panel.

The present invention relates to a component for use by an occupant in an interior of a vehicle comprising a housing comprising a compartment and a cover configured to cover the compartment. The compartment may be configured to receive a key fob for the vehicle. The component may be configured to be shipped together with the key fob and installed into the vehicle interior as a unit. The component may be configured to be removed by the occupant after installation into the vehicle interior. The cover may be configured to move to an open position for access to the key fob. The component may be configured to be installed in the interior of the vehicle. The component may be configured to be removed from the interior of the vehicle for use by the occupant outside of the vehicle. The component may comprise a retention feature configured to retain the key fob. The component may be configured to retain a key card for the vehicle. The component may be configured to be shipped together with the key card and installed into the vehicle interior as a unit. The component may comprise a retention feature configured to retain the key card. The cover may comprise a lid. The component may comprise a hinge for the cover. The cover may be configured to move between a closed position to cover the compartment and an open position to uncover the compartment. The cover may comprise a top side. The top side of the cover may comprise a label. The cover may comprise a bottom side facing the compartment. The bottom side of the cover may comprise a key card for the vehicle. The bottom side of the cover may comprise a retention feature configured to retain a key card for the vehicle. The component may comprise a hole configured for a ring. The cover may comprise a tab comprising the hole. The component may comprise a latch configured to retain the cover to the housing. The component may provide a data interface. The data interface may be configured for interaction and/or connection with a scanner. The component may comprise a label comprising data or information. The component may comprise a label comprising at least one of (a) a vehicle identification number; (b) a bar code; (c) a QR code, (d) a tag, (e) an RFID tag, (f) a data tag, (g) a transmitter. The component may comprise a label configured for at least one of (a) serializing the key fob to the vehicle; (b) tracking; (c) matching; (d) monitoring; (e) authenticating; (f) identification; (g) serialization; (h) communication; and/or (i) an instruction. The component may comprise a label; use by an occupant may comprise scanning the label. The housing may comprise an attachment feature configured to retain the housing in the interior of the vehicle. The component may be configured for installation in a subassembly for the vehicle interior. The subassembly for the vehicle interior may comprise at least one of (a) a cup holder; (b) a floor console; (c) a center console; (d) a door; (e) a cockpit; (f) an instrument panel. A subassembly for the vehicle interior may comprise the component. The subassembly may comprise a module for the key fob. The key fob may comprise a set of key fobs.

The present invention relates to a method of installing a key in a vehicle interior comprising the steps of installing the key in a component and installing the component in a subassembly for the vehicle interior. The key may comprise at least one of a key fob and/or a key card. The method may comprise the step of installing a module for the key to the subassembly for the vehicle interior. The method may comprise the step of installing the subassembly for the vehicle interior in the vehicle interior. The component may comprise a housing comprising a compartment and a cover configured to cover the compartment. The step of installing the key in a component may comprise placing the key in the compartment. The step of installing the key in a component may comprise snapping the key onto the cover. The component may comprise a label. The method may comprise the step of scanning the label.

### FIGURES

FIG. 1A is a schematic perspective view of a vehicle according to an exemplary embodiment.

FIG. 1B is a schematic perspective cut-away view of a vehicle showing a vehicle interior according to an exemplary embodiment.

FIG. 2 is a schematic perspective cut-away view of a vehicle showing a vehicle interior according to an exemplary embodiment.

FIG. 3 is a schematic perspective view of a component for a vehicle interior according to an exemplary embodiment.

FIG. 4A is a schematic exploded perspective view of a component for a vehicle interior according to an exemplary embodiment.

FIG. 4B is a schematic perspective view of a component for a vehicle interior according to an exemplary embodiment.

FIG. 5A is a schematic exploded perspective view of a component for a vehicle interior according to an exemplary embodiment.

FIG. 5B is a schematic perspective view of a component is a schematic perspective view of a component.

FIG. 6A is a schematic perspective view of a component for a vehicle interior according to an exemplary embodiment.

FIG. 6B is a schematic perspective view of a component for a vehicle interior according to an exemplary embodiment.

FIGS. 7A and 7B are schematic perspective cut-away views of a vehicle showing a vehicle interior according to an exemplary embodiment.

FIG. 8 is a schematic perspective view of components for a vehicle according to an exemplary embodiment.

FIG. 9 is a schematic perspective cut-away view of a vehicle showing a vehicle interior according to an exemplary embodiment.

FIG. 10 is a schematic perspective view of a component for a vehicle interior according to an exemplary embodiment.

FIG. 11A is a schematic exploded perspective view of a component for a vehicle interior according to an exemplary embodiment.

FIG. 11B is a schematic perspective view of a component for a vehicle interior according to an exemplary embodiment.

FIG. 12A is a schematic exploded perspective view of a component for a vehicle interior according to an exemplary embodiment.

FIG. 12B is a schematic perspective view of a component for a vehicle interior according to an exemplary embodiment.

FIG. 13A is a schematic perspective view of a component for a vehicle interior according to an exemplary embodiment.

FIG. 13B is a schematic perspective view of a component for a vehicle interior according to an exemplary embodiment.

FIGS. 14A and 14B are schematic perspective cut-away views of a vehicle showing a vehicle interior according to an exemplary embodiment.

FIGS. 15A through 15C are schematic block diagrams of a system according to an exemplary embodiment.

FIGS. 16A through 16J are schematic block diagrams of a system according to an exemplary embodiment.

FIGS. 17A through 17D are schematic block diagrams of a system according to an exemplary embodiment.

FIGS. 18A through 18F are schematic block diagrams of a system according to an exemplary embodiment.

FIGS. 19A and 19F are schematic block diagrams of a system according to an exemplary embodiment.

FIGS. 20A through 20G are schematic block diagrams of a system according to an exemplary embodiment.

FIG. 21 is a schematic block diagram of a system according to according to an exemplary embodiment.

FIGS. 22A through 22D are schematic flow diagrams of methods of manufacturing/assembling a component for an interior of a vehicle according to an exemplary embodiment.

FIG. 23 is a schematic flow diagram of a method of manufacturing/assembling a component for an interior of a vehicle according to an exemplary embodiment.

FIG. 24A is a schematic flow diagram of a method of manufacturing/assembling a component for an interior of a vehicle according to an exemplary embodiment.

FIG. 24B is a schematic flow diagram of a method of manufacturing/assembling a component for an interior of a vehicle according to an exemplary embodiment.

FIG. 25A is a schematic flow diagram of a method of manufacturing/assembling a component for an interior of a vehicle according to an exemplary embodiment.

FIG. 25B is a schematic flow diagram of a method of manufacturing/assembling a component for an interior of a vehicle according to an exemplary embodiment.

### DESCRIPTION

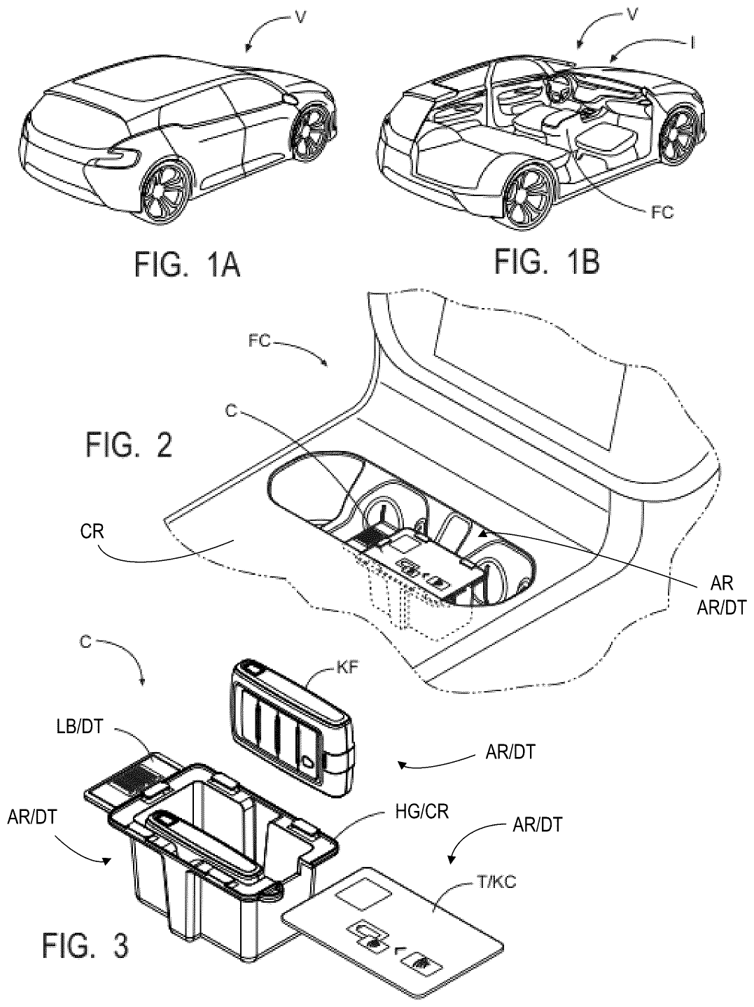

Referring to FIGS. 1A and 1B, a vehicle V is shown including an interior I with components C such as a floor console FC; the component C for an interior I of the vehicle V may be configured to contain a compartment CR for an article AR containing data DT for the vehicle; the compartment CR may comprise a housing HG; data DT may be contained on the article AR; the article AR may be installed/assembled with the compartment CR for the interior I of the vehicle; data DT associated with the article AR may be contained in the compartment CR (e.g. with/on the article in the compartment/housing) in the interior of the vehicle. See also FIGS. 2A-2B, 3, 4A-4B, 5A-5B, 6A-6B, 7A-7B, 8, 9, 10, 11A-11B, 12A-12B, 13A-13B and 14A-14B.

According to an exemplary embodiment as shown schematically in the FIGURES, a component C for an interior I of a vehicle V configured to contain an article AR containing data DT for the vehicle may comprise a housing comprising a compartment CR; the compartment may be configured to contain the article.

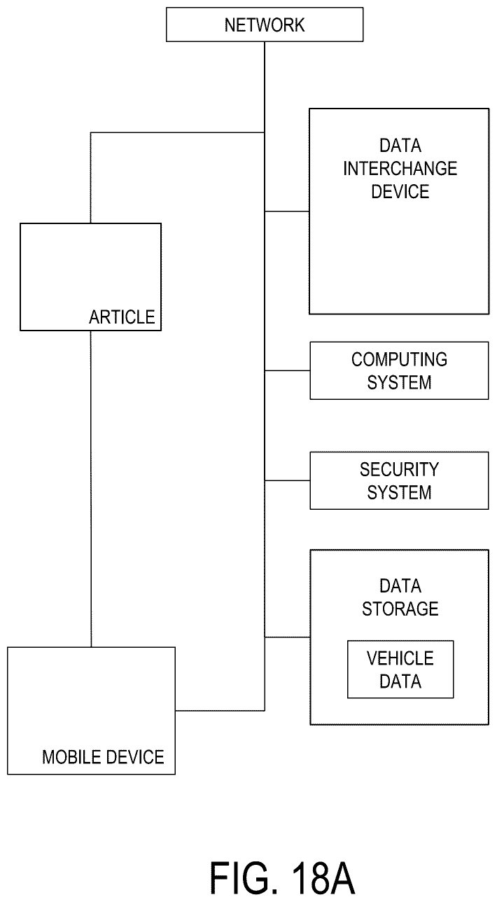

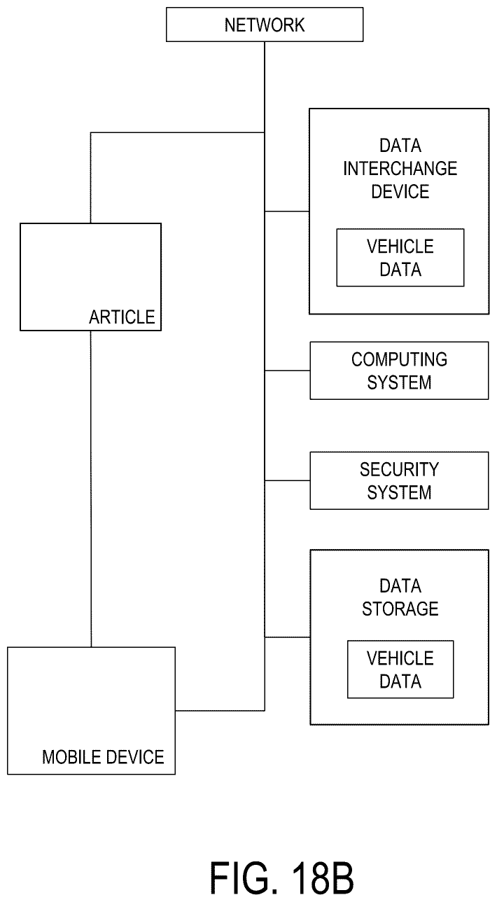

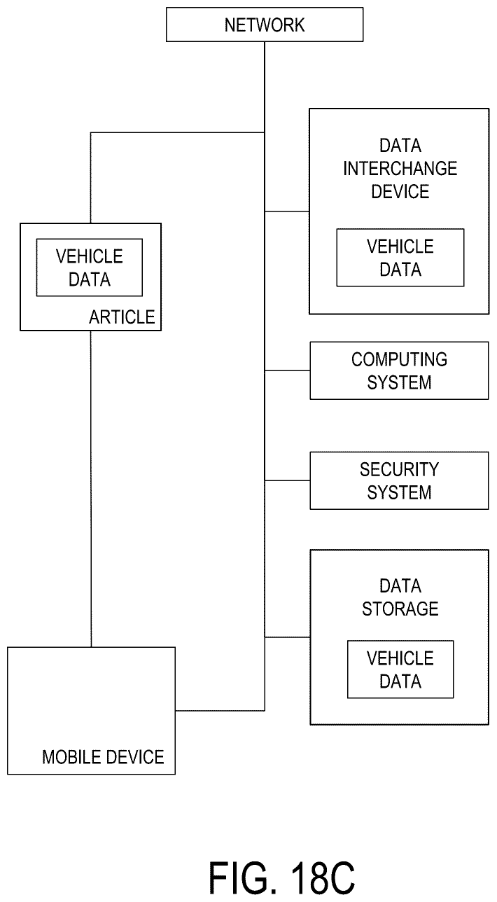

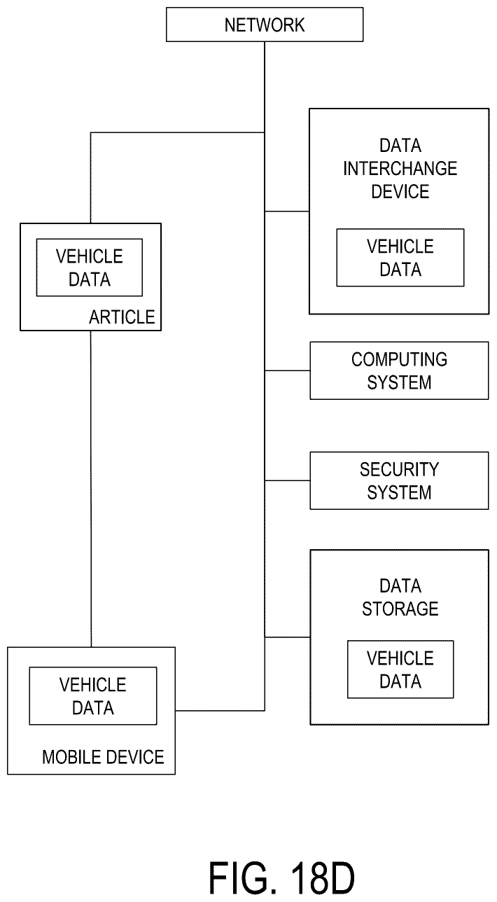

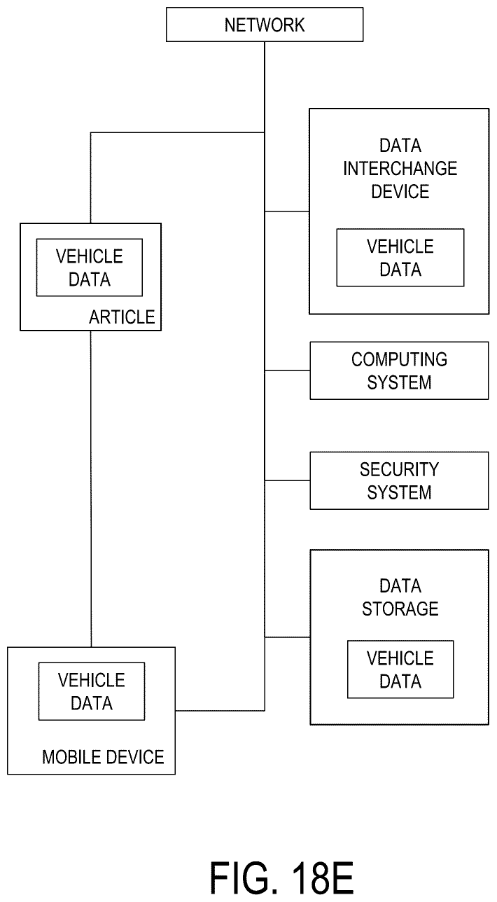

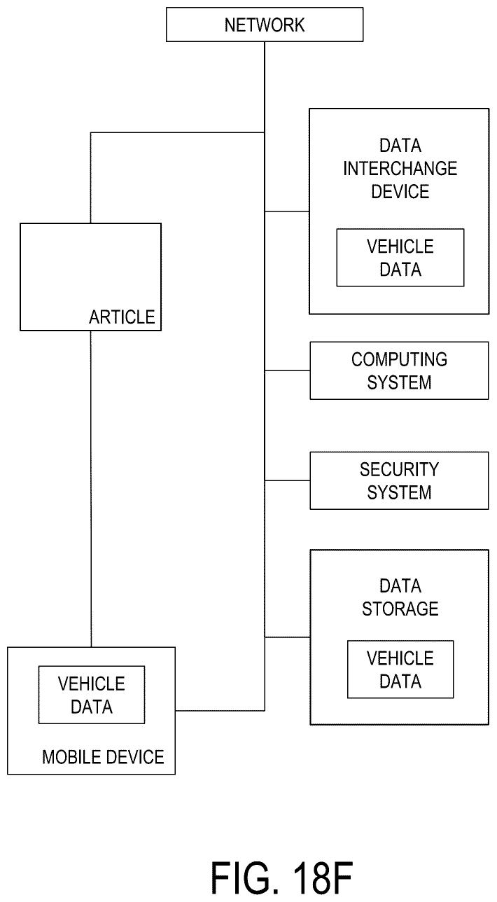

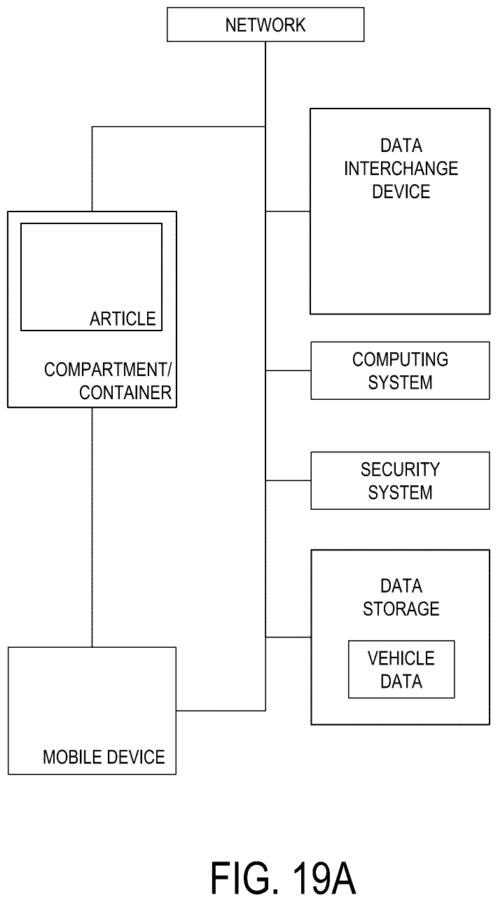

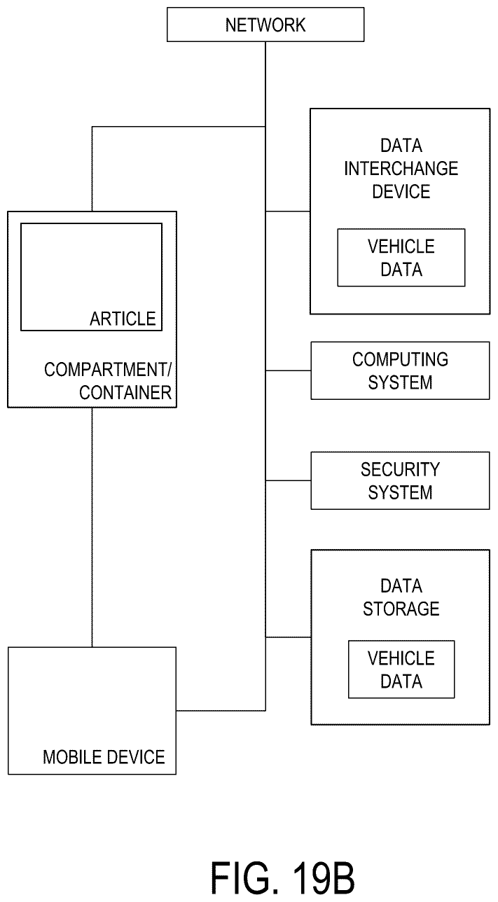

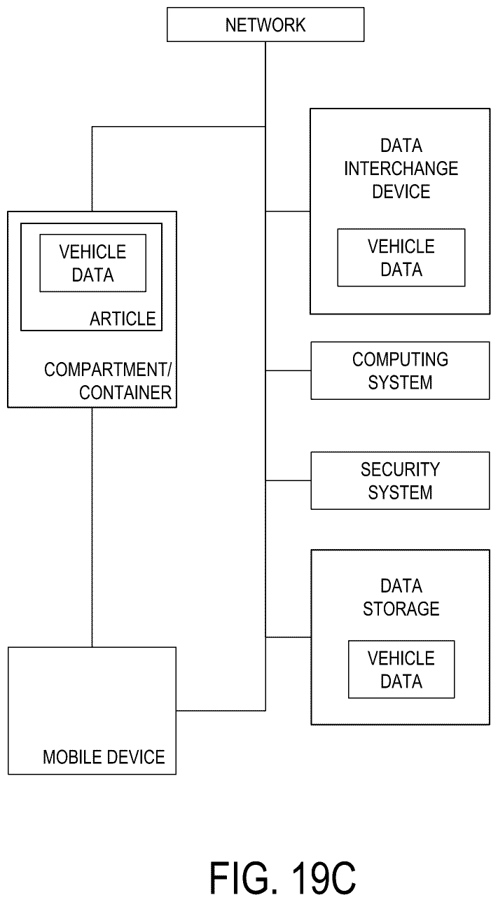

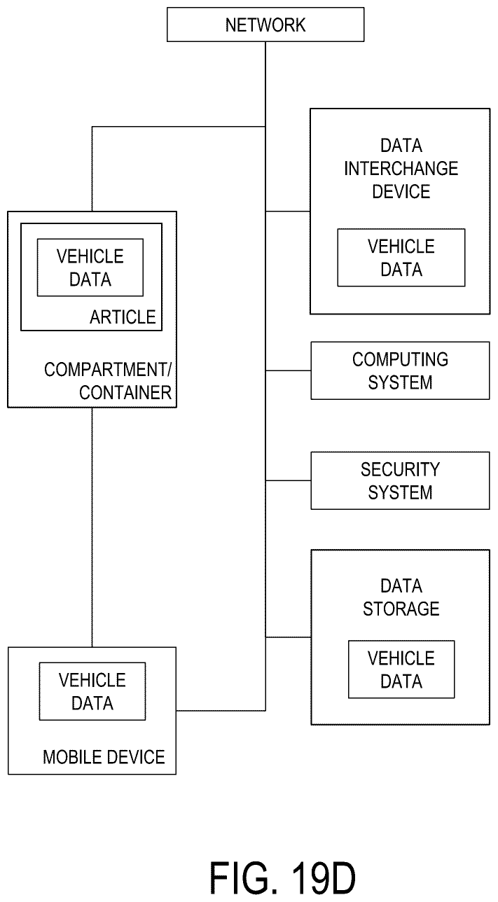

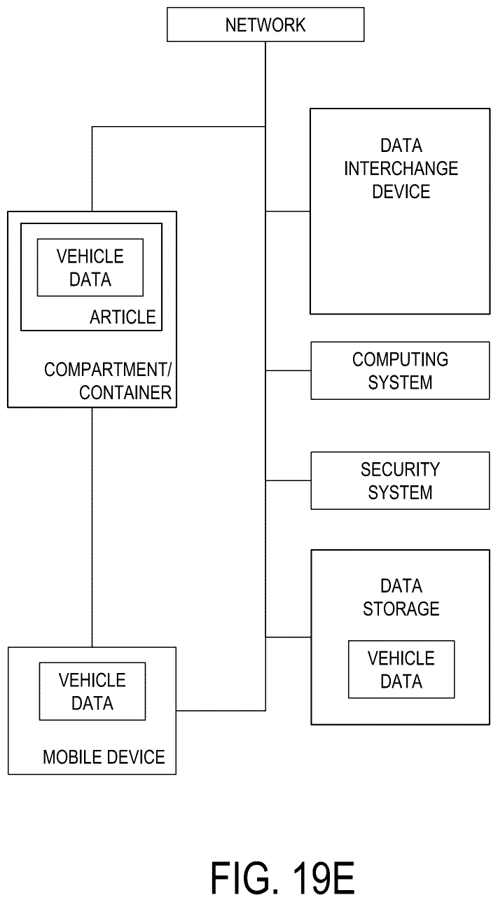

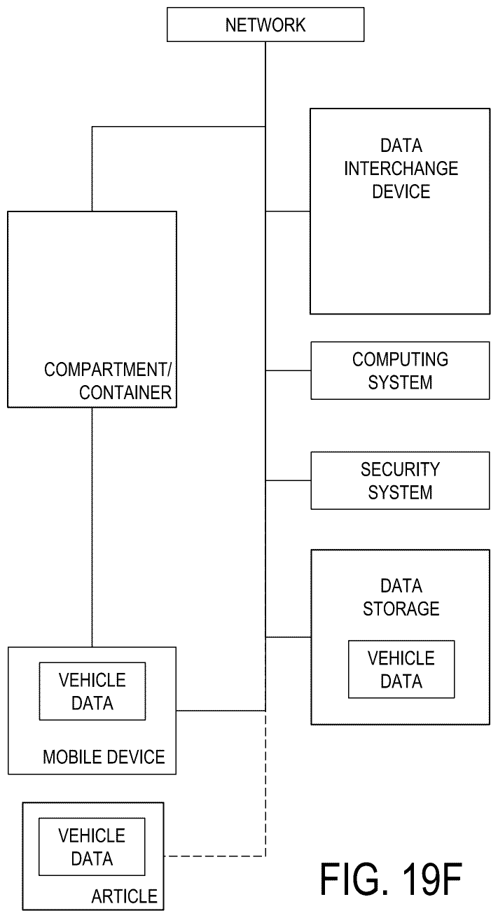

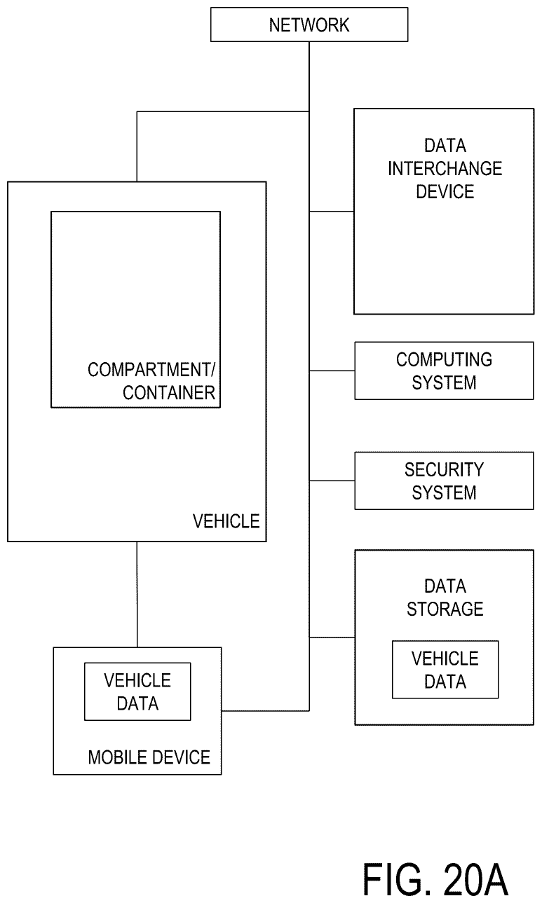

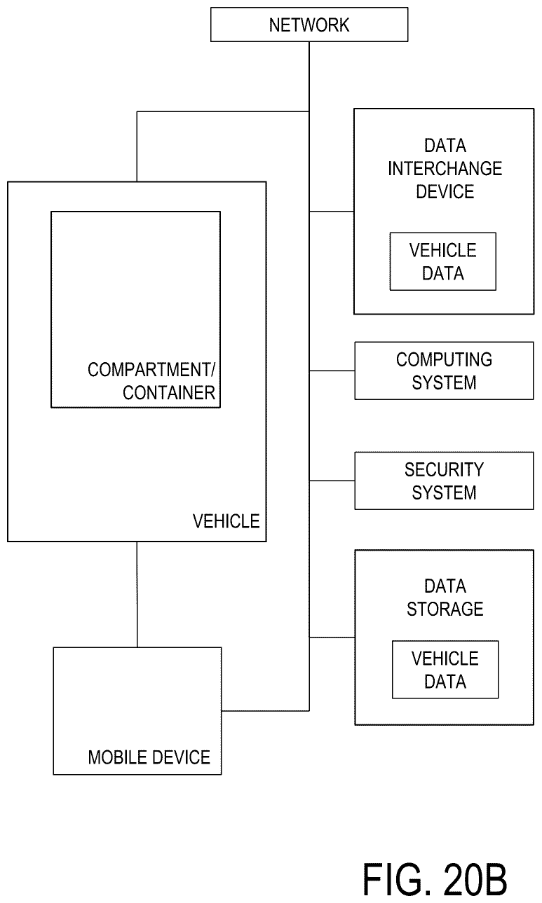

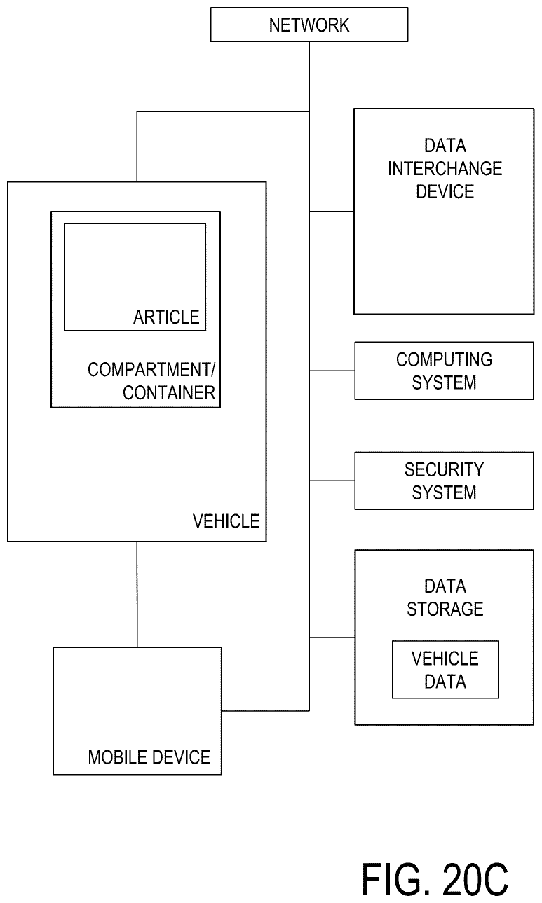

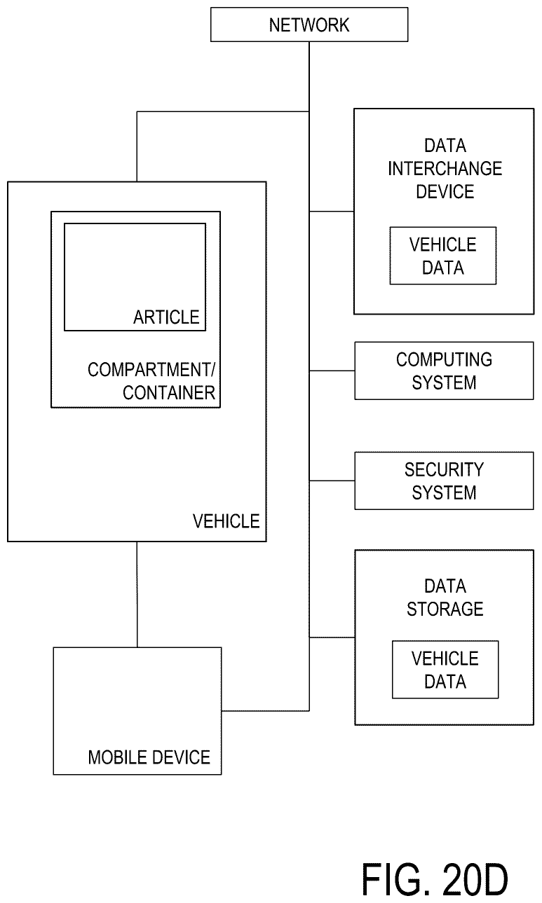

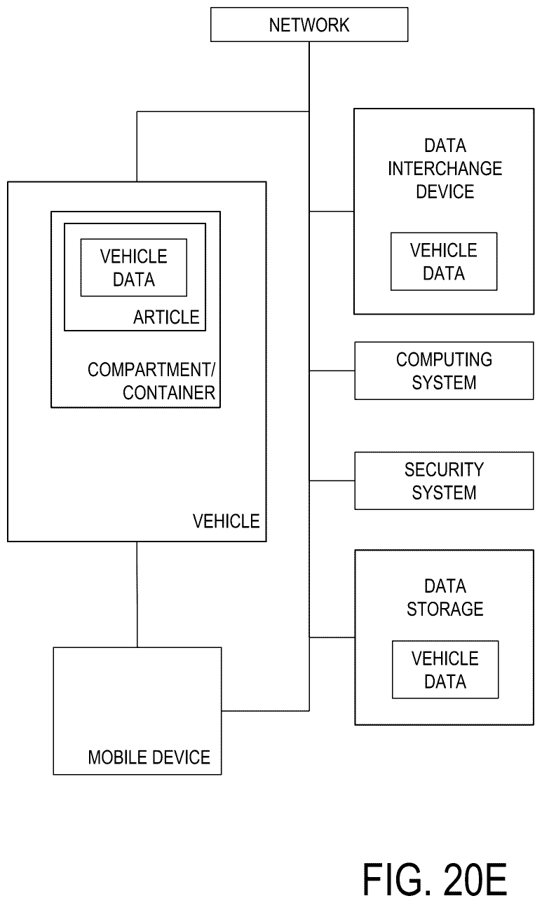

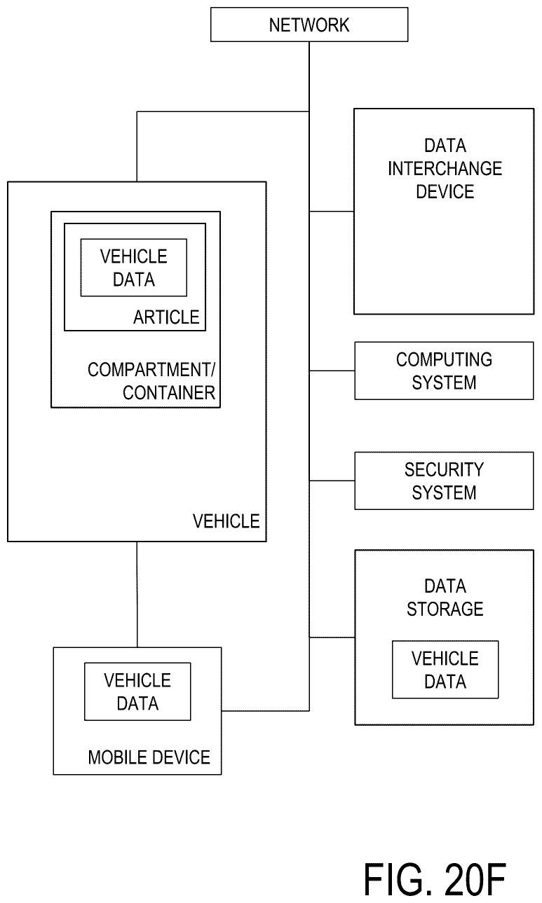

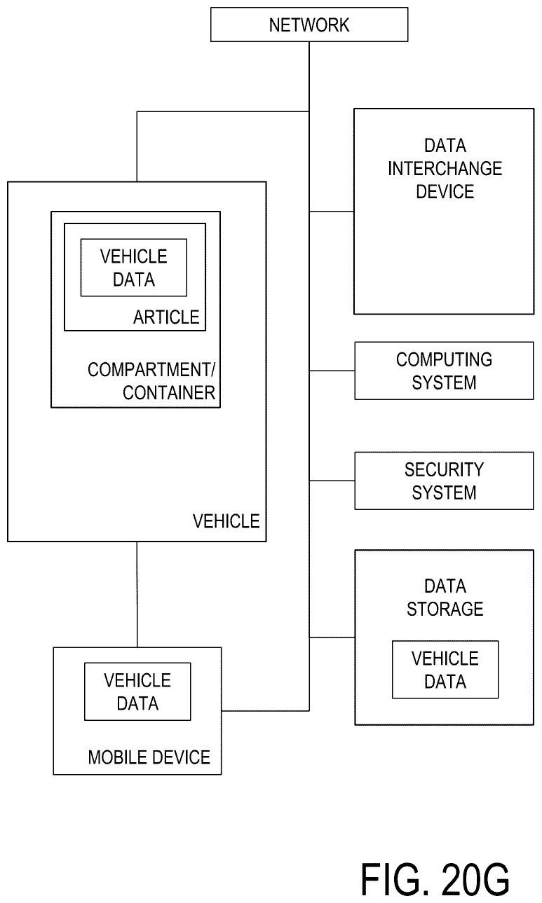

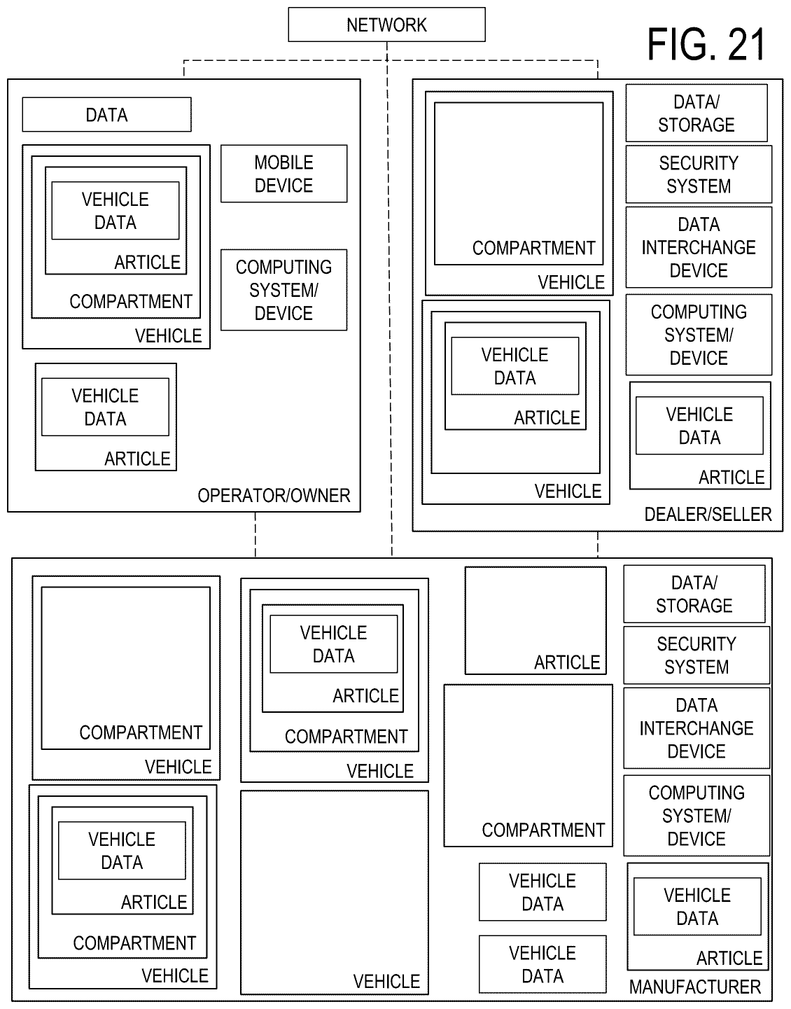

As indicated schematically in FIGS. 2A-2B, 3, 4A-4B, 5A-5B, 6A-6B, 7A-7B, 8, 9, 10, 11A-11B, 12A-12B, 13A-13B, 14A-14B, 15A-15C, 16A-16J, 17A-17D, 18A-18F, 19A-19F and 20A-20G and 21, the system for data/operation with the component may be configured to facilitate the article AR and/or the article with vehicle data AR/DT and/or the vehicle data DT to be transported/transmitted separately from the vehicle; the article AR and/or the article with vehicle data AR/DT and/or the vehicle data DT may be transported with the vehicle V in the compartment CR in the interior of the vehicle.

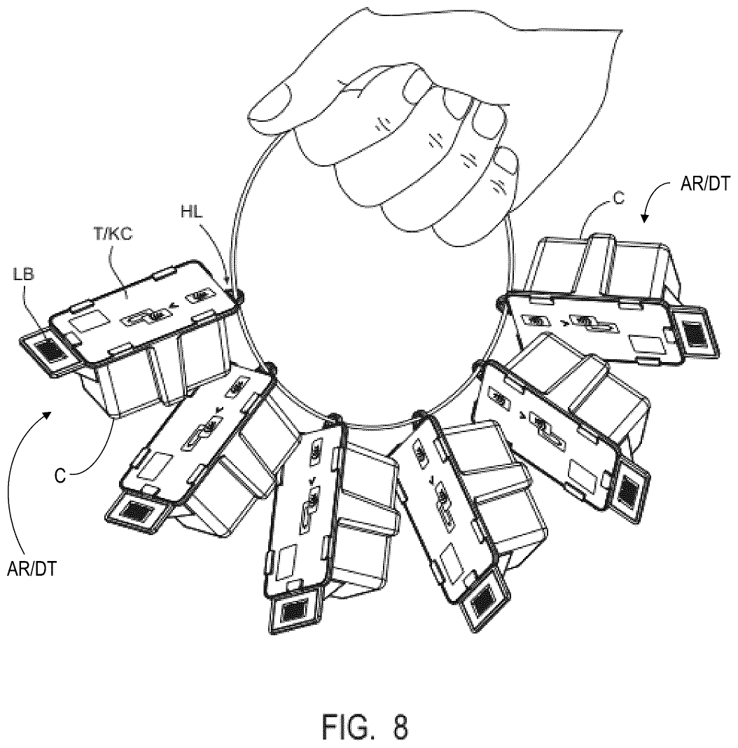

As indicated schematically in FIGS. 2A-2B, 3, 4A-4B, 5A-5B, 6A-6B, 7A-7B, 8, 9, 10, 11A-11B, 12A-12B, 13A-13B, 14A-14B, 15A-15C, 16A-16J, 17A-17D, 18A-18F, 19A-19F and 20A-20G and 21, the system for data/operation with the component may be configured to facilitate data interchange/transmission between the article AR and/or the article with vehicle data AR/DT and/or the vehicle data DT and/or the vehicle and/or data storage and/or computing systems, etc.; the article AR and/or a tag/label LB configured to contain data DT may be communicated through a data interchange device such as a code scanner DG and or to/through a module with a data interface DC for a data interchange and/or computing/security system (see FIGS. 2A-2B, 3, 4A-4B, 5A-5B, 6A-6B, 7A-7B, 8, 9, 10, 11A-11B, 12A-12B, 13A-13B and 14A-14B); the article AR and/or multiple articles associated with one or multiple vehicles may be transported collectively (see FIG. 8).

As indicated schematically in FIGS. 2A-2B, 3, 4A-4B, 5A-5B, 6A-6B, 7A-7B, 8, 9, 10, 11A-11B, 12A-12B, 13A-13B, 14A-14B, 15A-15C, 16A-16J, 17A-17D, 18A-18F, 19A-19F and 20A-20G and 21, the article AR configured to contain data DT for use/operation of the system/component may comprise a key, an electronic key unit, a card, a card containing data, a key card. a fob, a key fob, a label, a tag, a data tag, and electronic tag, a detectable tag, a scannable tag, a scannable label, a code, a readable code, a tag configured for data interchange with a data interchange device, a tag configured for data interchange to a computing device, a tag configured for data interchange to a mobile device, etc.

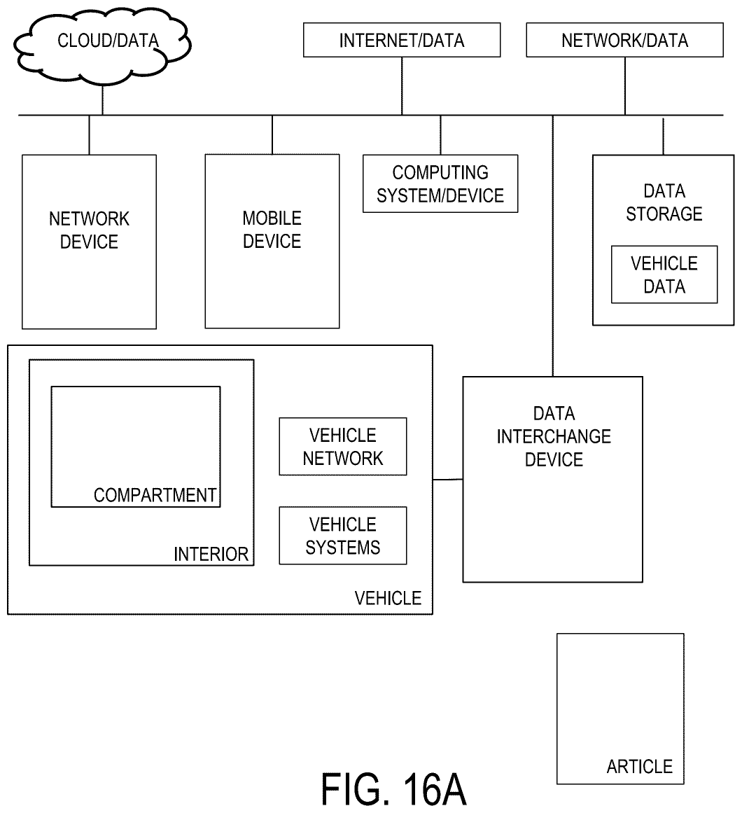

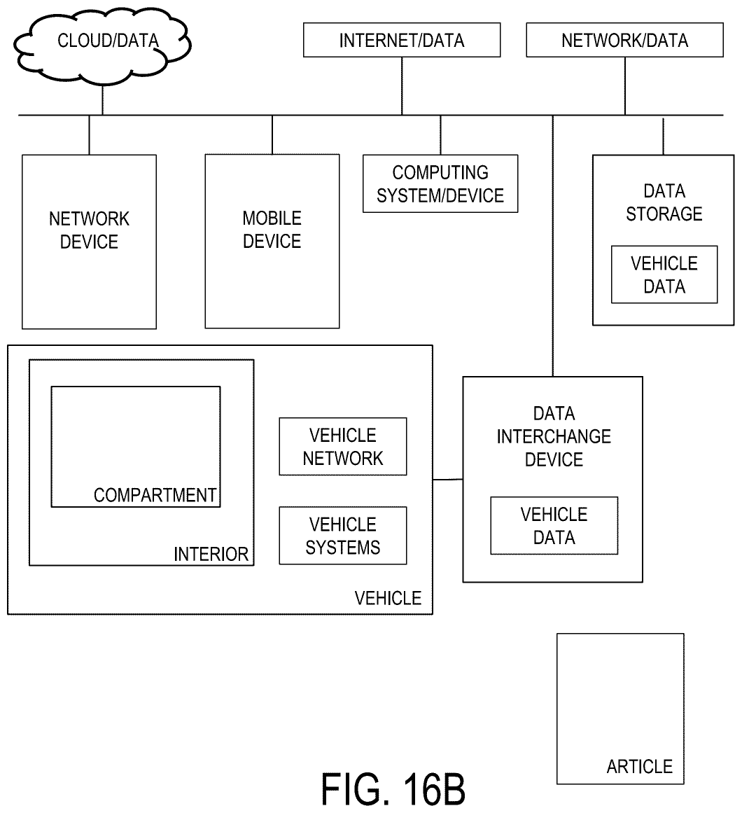

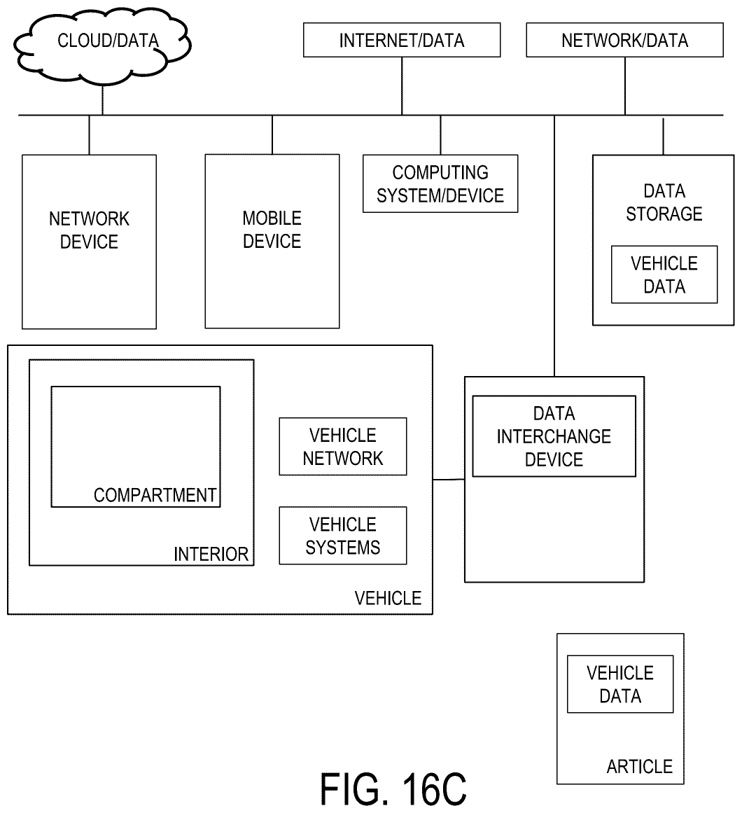

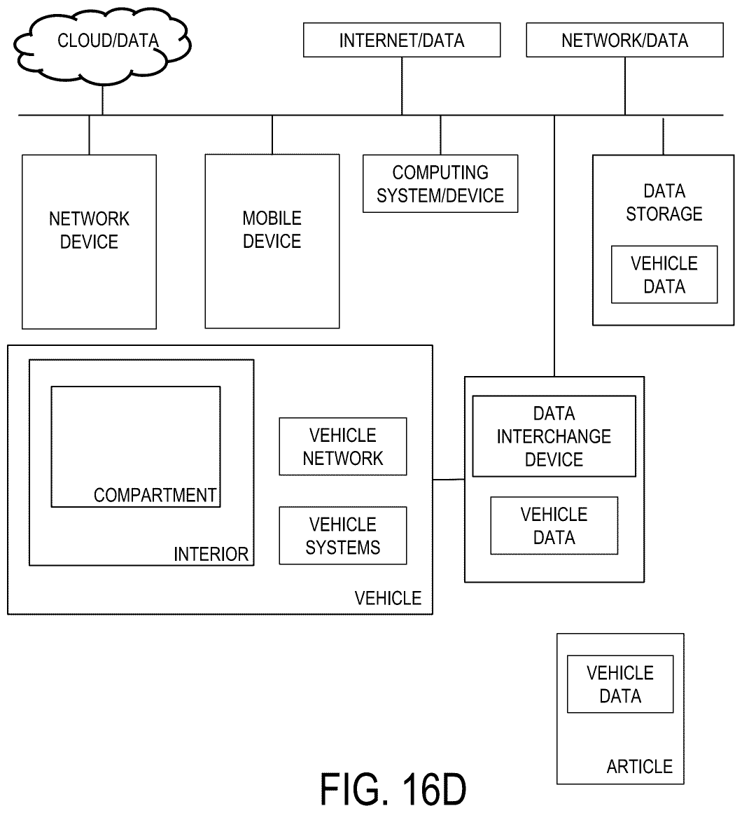

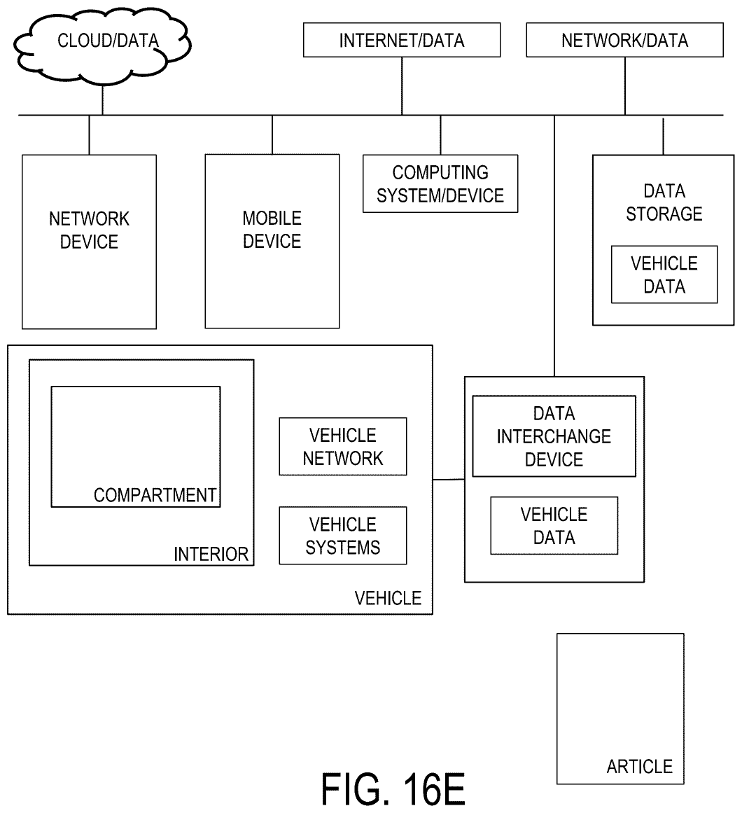

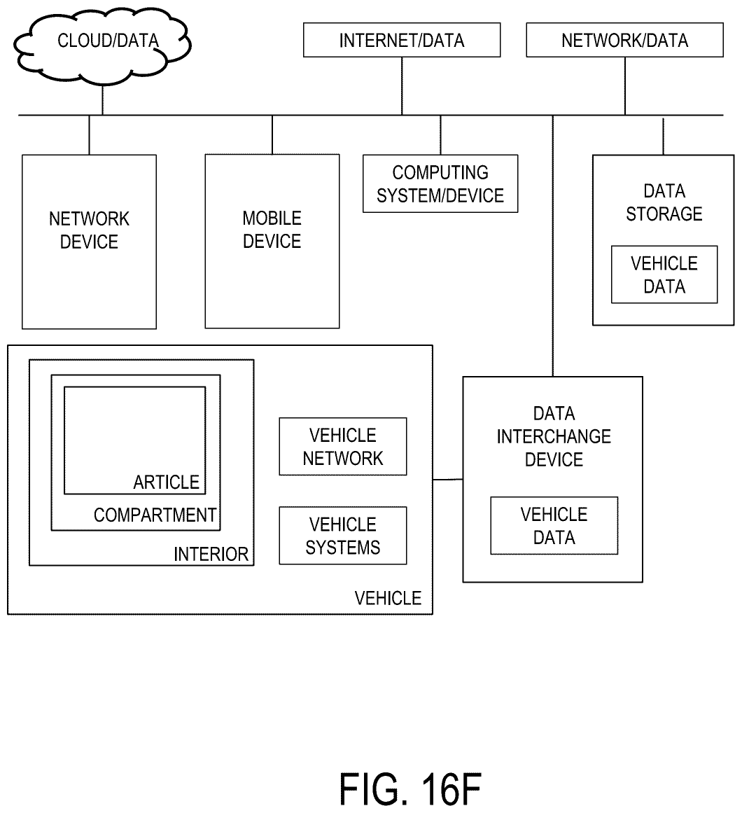

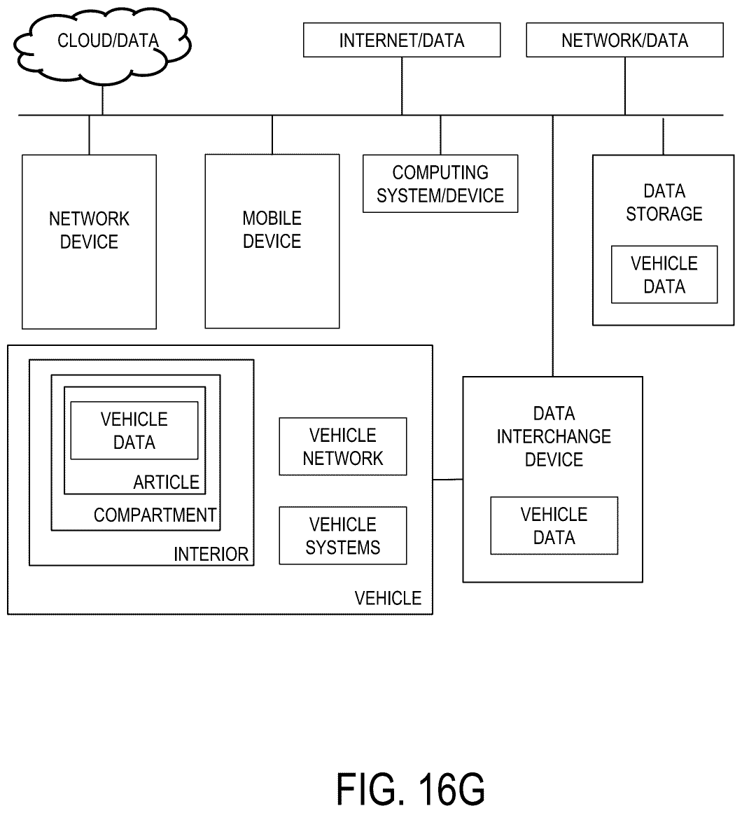

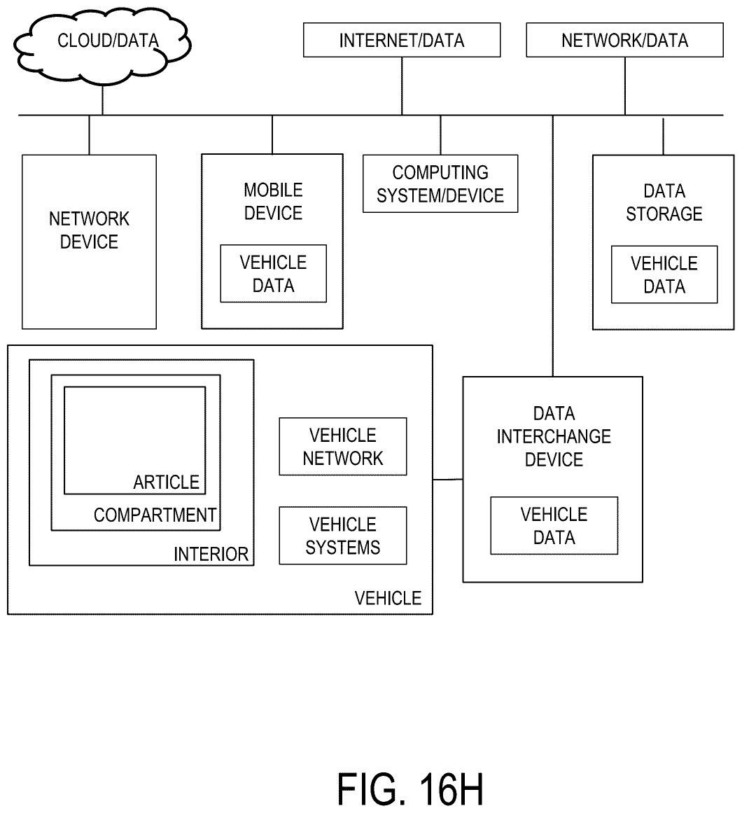

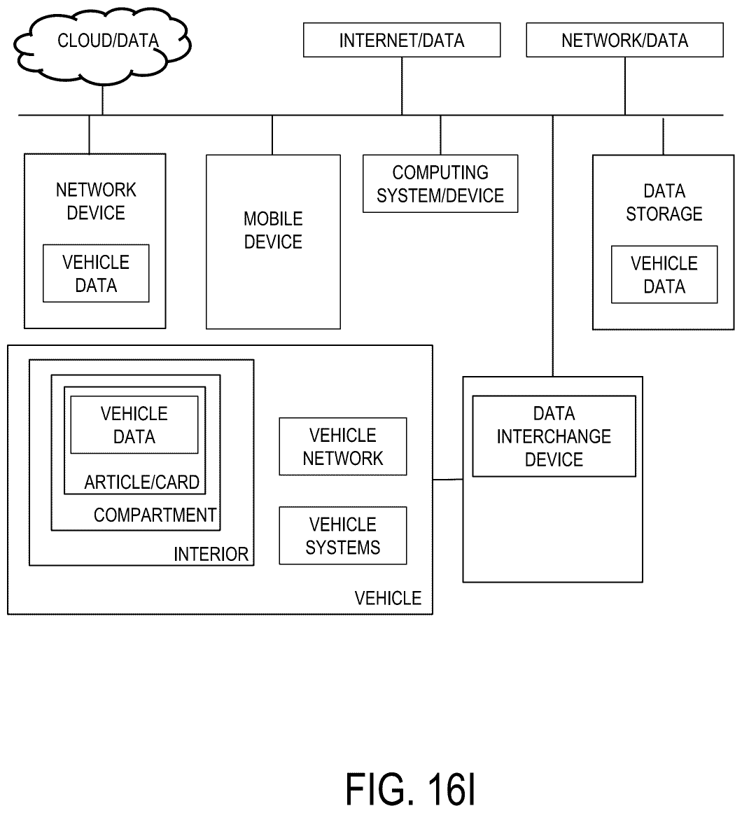

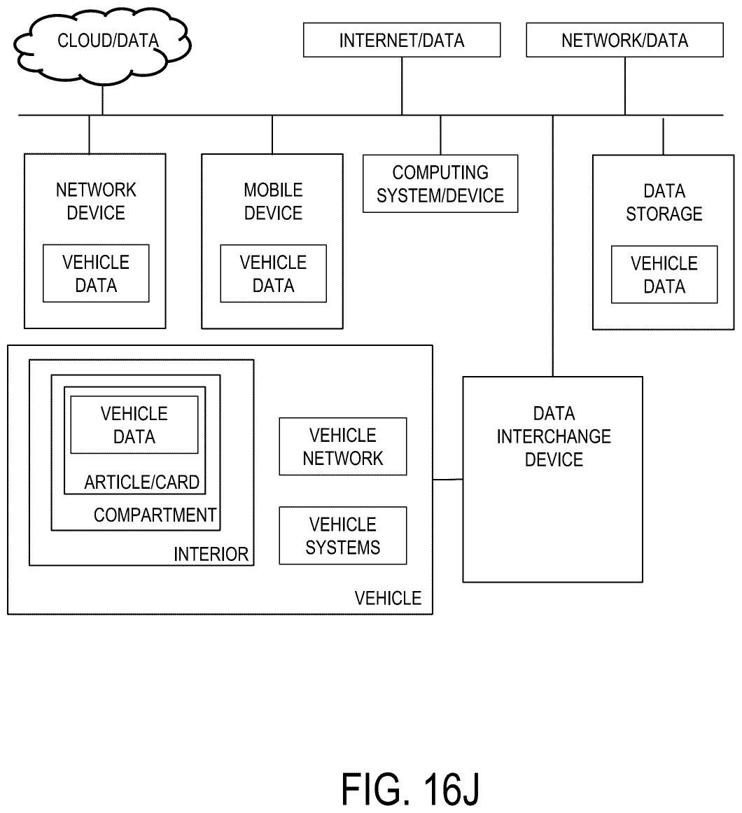

As indicated schematically in FIGS. 16A-16J, 17A-17D, 18A-18F, 19A-19F and 20A-20G and 21, the article containing data AR/DT for the system may be configured for electronic data interchange and/or wireless data interchange; the article containing data AR/DT (such as on a tag or label LB) may be configured for data interchange with a data interchange device shown as a scanner DG (or such as a reader, code reader, scanner, scanning device, mobile device configured by application, etc. to operate as a code scanner, etc.); the article AR configured to contain data DT may comprise a tag such as a label LB containing data; data from the tag may be configured for data interchange; the tag may comprise at least one of an electronic tag configured for electronic/wireless data interchange and/or a label configured to be detected by a data interchange device; the tag may comprise an electronic tag for the article and/or a label on the article. See also FIGS. 2A-2B, 3, 4A-4B, 5A-5B, 6A-6B, 7A-7B, 8, 9, 10, 11A-11B, 12A-12B, 13A-13B and 14A-14B.

As indicated schematically in FIGS. 16A-16J, 17A-17D, 18A-18F, 19A-19F and 20A-20G and 21, the system for containing/interchange of vehicle data with the article/compartment may comprise data/network systems including for data security/security, data interchange, communications with devices such as network devices and mobile devices (e.g. to provide key/access capability for the vehicle), data interchange devices to facilitate interchange of data to a mobile device or other devices, etc. operating with a computing system, data storage, etc.

As indicated schematically in the FIGURES, a component for a system for containing/interchange of data on an article for a compartment in an interior of a vehicle may comprise a compartment for the article (e.g. a data card, key card, key fob, etc.); the component may be configured to retain the article such as the key card; the component may be shipped with an article such as the key fob and/or key card and installed into the vehicle interior as a unit. The component may comprise a feature to retain the article/key card; the retention feature may provide a gap/slot through which the key card may slide for installation to a housing of the compartment. The article/card may provide a cover for compartment; the component may provide a label/data interface for interaction and/or connection (e.g. with a code scanner, mobile device camera, etc.). The component may be installed, press-fit and/or a snap-fit in a subassembly (e.g. a cup holder, floor/center console, door, cockpit, or an instrument panel). The subassembly may comprise a module for the article such as the key fob and/or key card. Vehicle data to be associated with the article/vehicle may be interchanged/transmitted on data/network systems including for data security/security, data interchange, communications with devices such as network devices and mobile devices (e.g. to provide key/access capability for the vehicle), data interchange devices to facilitate interchange of data to a mobile device or other devices, etc. operating with a computing system, data storage, etc.

### Exemplary Embodiments—A

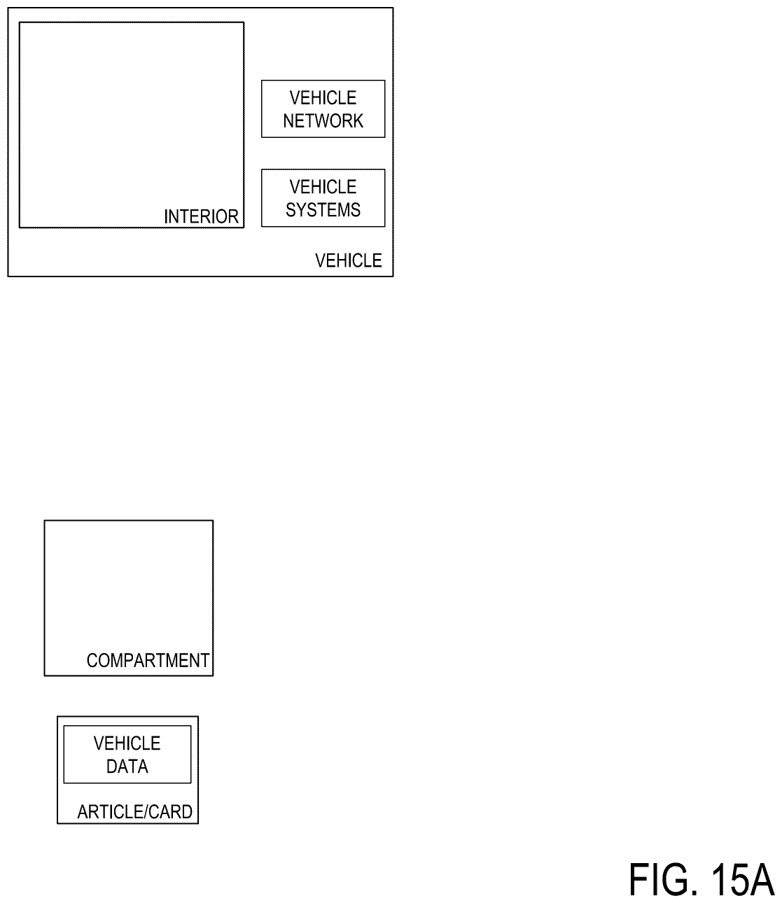

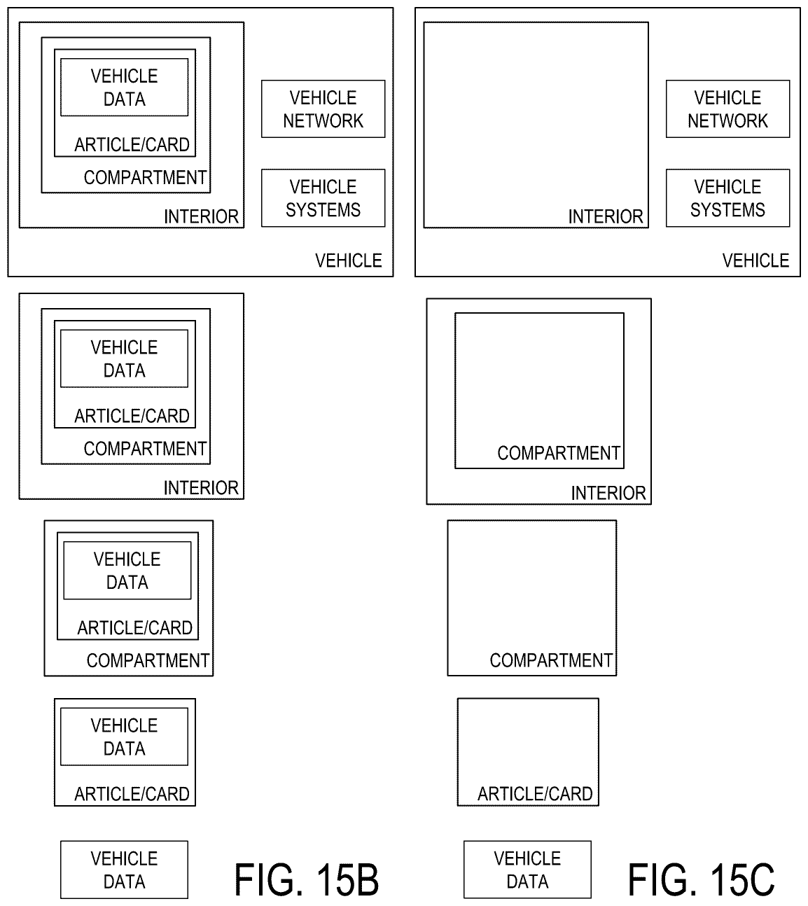

According to an exemplary embodiment as shown schematically in FIGS. 2A-2B, 3, 4A-4B, 5A-5B, 6A-6B, 7A-7B, 8, 9, 10, 11A-11B, 12A-12B, 13A-13B and 14A-14B, a component C for an interior I of a vehicle V configured to contain an article AR containing data DT for the vehicle may comprise a housing comprising a compartment CR; the compartment CR may be configured to contain the article AR and/or the article containing data AR/DT. See also FIGS. 15A-15C, 16A-16J, 17A-17D, 18A-18F, 19A-19F and 20A-20G and 21.

As indicated schematically in FIGS. 16A-16J, 17A-17D, 18A-18F, 19A-19F and 20A-20G and 21, the system with the component may be configured to facilitate the article with vehicle data and/or the article to be transported/transmitted separately from the vehicle and/or for the article with vehicle data to be transported with the vehicle in the compartment in the interior of the vehicle. The component for the system may comprise a feature configured to retain the article in the housing. The article may comprise at least one of (a) a key; (b) an electronic key unit; (c) a card; (d) a card containing data; (e) a key card; (f) a fob; (g) a key fob; (h) a label; (i) a tag; (j) a data tag; (k) and electronic tag; (l) a detectable tag; (m) a scannable tag; (n) a scannable label; (o) a code; (p) a readable code; (q) a tag configured for data interchange with a data interchange device; (r) a tag configured for data interchange to a computing device; (s) a tag configured for data interchange to a mobile device. The feature may be configured to provide a receptacle for a key card; so that the key card may be configured to be retained in the housing. The feature may comprise a retention feature comprising an L-shaped tab provided on the housing. The feature may be configured to provide a slot for a key card; the slot may comprise a gap; the key card may be configured to be inserted into the gap of the slot for installation in the housing. The feature may be configured to clamp a key card to the housing. The article may comprise a key card; the key card may be configured to provide a cover for the housing; the key card can be moved between a position to cover the compartment and a position to uncover the compartment. The housing may comprise a projection. The projection may comprise a tab. The tab may comprise a label; the label may be configured to comprise data and/or information. The tab may comprise a hole configured for a ring. The housing may comprise an attachment feature configured to retain the housing in the interior of the vehicle; the attachment feature may comprise a projection. The component may comprise a subassembly comprising the housing; the subassembly may be configured for installation in the interior of the vehicle. The housing may be configured for installation in the subassembly by at least one of press-fit assembly and/or snap-fit assembly. The subassembly may comprise at least one of (a) a cup holder; (b) a floor console; (c) a center console; (d) a door; (e) a cockpit; (f) an instrument panel; (g) a module for the article within the compartment. The article containing data may be configured for electronic data interchange and/or wireless data interchange. The article containing data may be configured for data interchange with a data interchange device. The article containing data may comprise a tag containing data; data from the tag may be configured for data interchange; the tag may comprise at least one of (a) an electronic tag configured for electronic/wireless data interchange and/or (b) a label configured to be detected by a data interchange device. The tag may comprise an electronic tag for the article and/or a label on the article.

According to an exemplary embodiment as shown schematically in the FIGURES, a method of providing interchange of data for a vehicle with a component for an interior of the vehicle configured to contain an article containing data for the vehicle may comprise the steps of providing a compartment for the article in the interior of the vehicle, providing the article with data relating to the vehicle, associating the article with the vehicle by data interchange, transporting the article for the vehicle, and installing the component in a subassembly for the interior of the vehicle. Transporting the article may comprise at least one of (a) transporting the article in the compartment of the vehicle or (b) transporting the article with the vehicle or (c) transporting the article separately from the vehicle or (d) transporting the article separately from the compartment. The article may comprise at least one of (a) a key; (b) an electronic key unit; (c) a card; (d) a card containing data; (e) a key card; (f) a fob; (g) a key fob; (h) a label; (i) a tag; (j) a data tag; (k) and electronic tag; (l) a detectable tag; (m) a scannable tag; (n) a scannable label; (o) a code; (p) a readable code; (q) a tag configured for data interchange with a data interchange device; (r) a tag configured for data interchange to a computing device; (s) a tag configured for data interchange to a mobile device; (t) a tag configured to provide a data interface. Data may comprise at least one of (a) vehicle data; (b) vehicle identification data; (c) vehicle identification number (VIN); (d) security data; (e) vehicle access data; (f) vehicle access data; (g) vehicle key data; (h) a bar code; (i) a QR code; (j) a tag; (k) an RFID tag; (l) a data tag; (m) scannable data; (n) visual data; (o) electronic data. Data interchange may comprise at least one of (a) data interchange for the vehicle; (b) data interchange for access to the vehicle; (c) data interchange for operation of the vehicle (d) data interchange for transmission to the vehicle; (e) data interchange for transmission from the vehicle; (f) associating the article for the vehicle; (g) associating a key unit with the vehicle; (h) associating a key fob with the vehicle; (i) tracking; (j) matching; (k) monitoring; (l) authenticating; (m) identification; (n) serialization; (o) communication; and/or (p) an instruction.

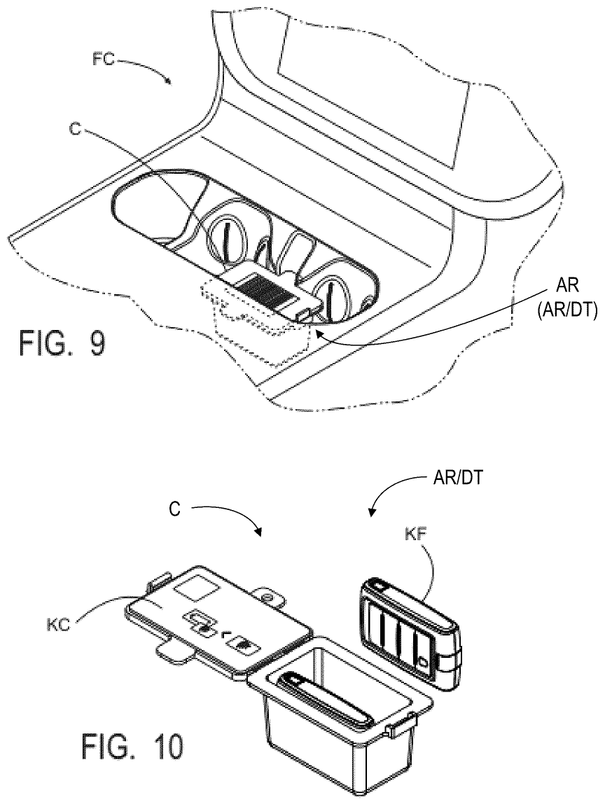

As indicated schematically according to an exemplary embodiment in FIGS. 15A through 15C, the system with component comprising a compartment and article configured for vehicle data can be associated/assembled with the interior of the vehicle (e.g. vehicle that may comprise computing system/device, vehicle systems, vehicle network, connectivity, etc.); vehicle data and/or the article can be provided in the compartment; vehicle data can be transmitted/interchanged on a network (e.g. cloud/cloud computing network, internet, local/other networks, etc.) and/or with a data interchange device to be provided to/from systems such as data storage, a computer system/device, a mobile device, a network device, etc.; as indicated schematically, the article with vehicle data and/or the article may be transported/transmitted separately from the vehicle. See also FIGS. 9B and 14B, 16A-16J, 17A-17D, 18A-18F, 19A-19F and 20A-20G. As indicated schematically in FIGS. 9B and 14B, 16A-16J, 17A-17D, 18A-18F, 19A-19F and 20A-20G, the system may be configured to facilitate data interchange to a mobile device that can be configured to operate as a key/key unit/security device for the vehicle.

Referring to FIGS. 16A-16J, data transmission/interchange is indicated schematically for the system between devices/networks with the article with vehicle data for the compartment in the interior of the vehicle according to according to an exemplary embodiment.

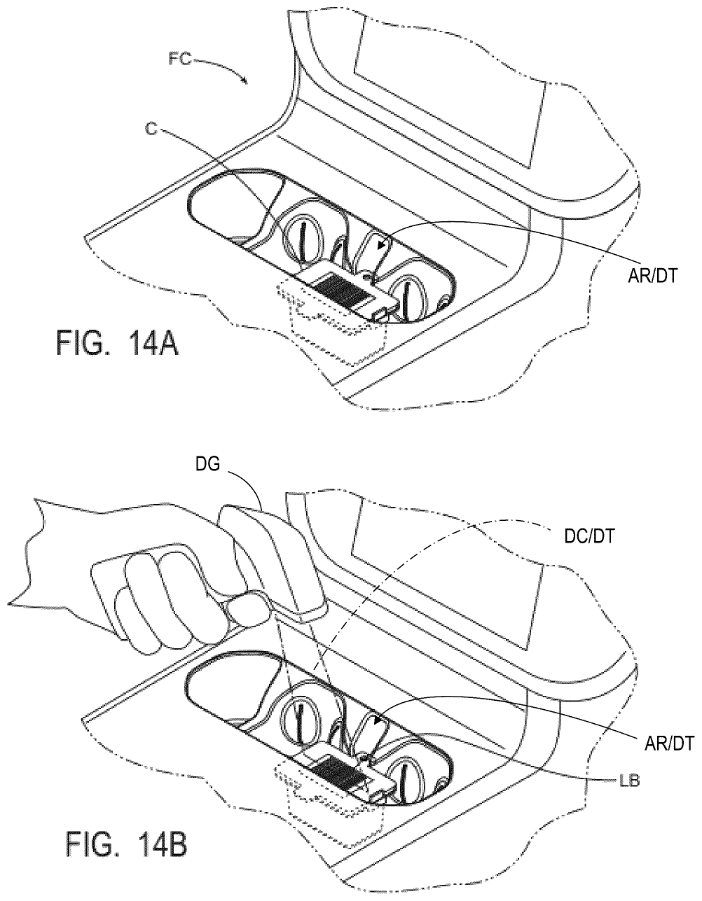

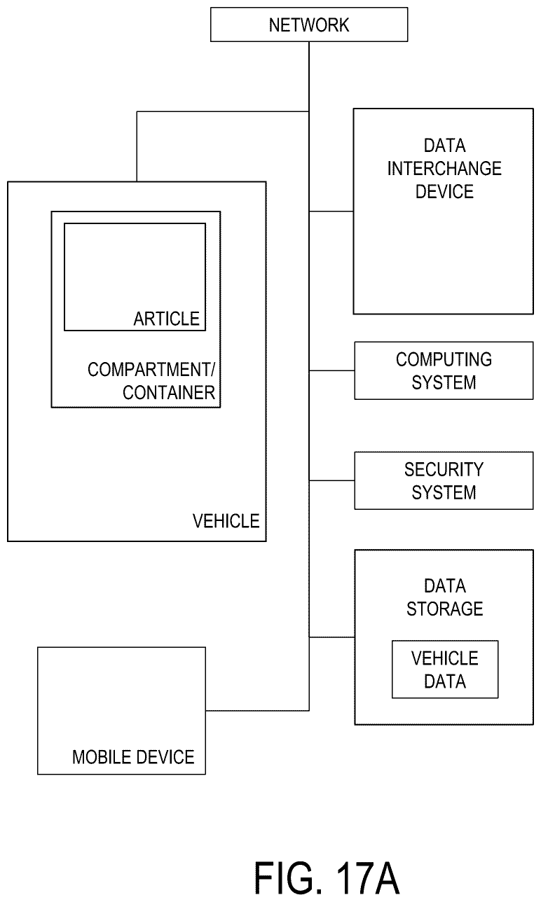

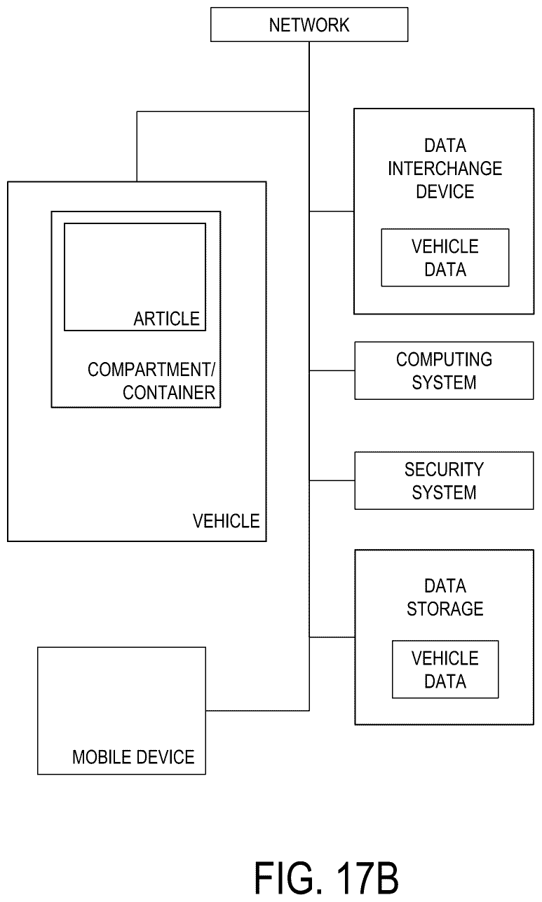

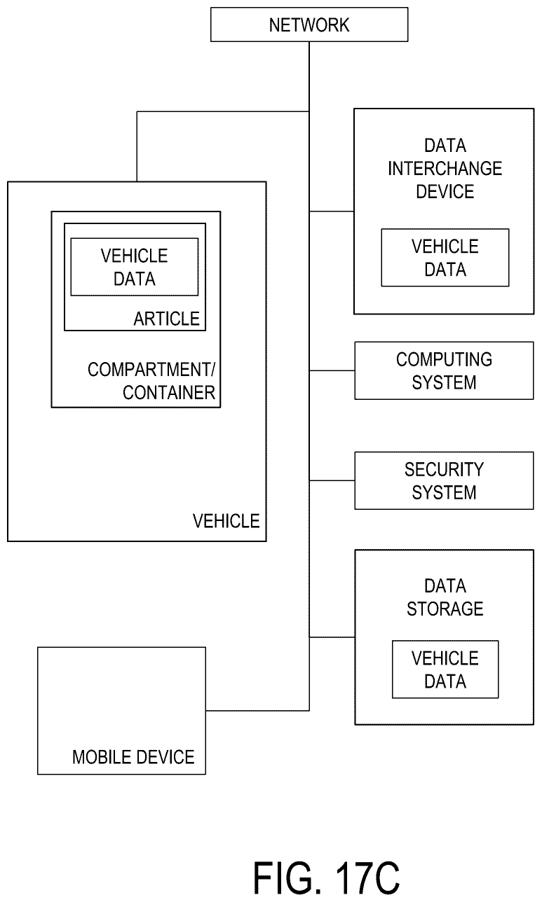

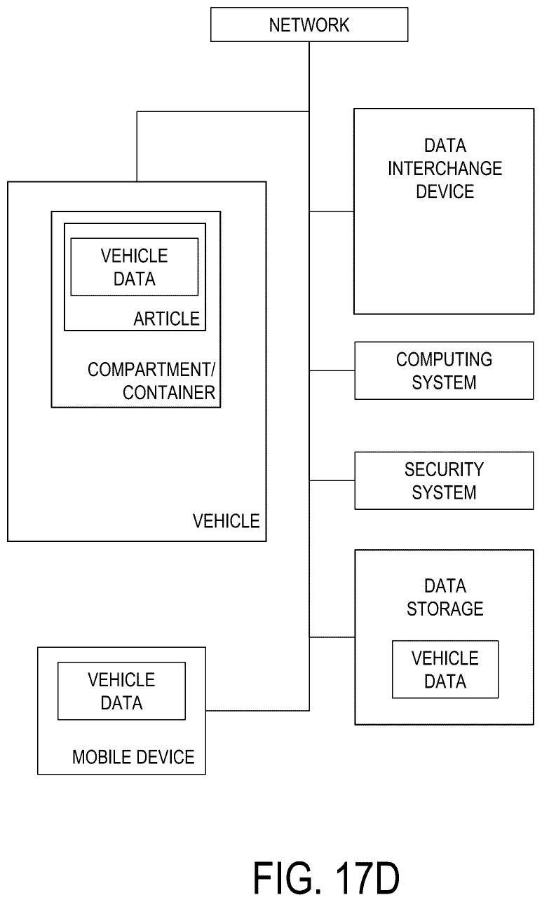

Referring to FIGS. 17A-17D, 18A-18F, 19A-19F and 20A-20G, data transmission/interchange is indicated schematically for the system between devices/networks with the article with vehicle data for the compartment in the interior of the vehicle including with a data interchange device according to according to an exemplary embodiment. See also FIGS. 9B and 14B.

As indicated schematically in FIGS. 16A-16J, 17A-17D, 18A-18F, 19A-19F and 20A-20G and 21, the system with network/devices may be configured to facilitate the article with vehicle data and/or the article to be transported/transmitted separately from the vehicle and/or for the article with vehicle data to be transported with the vehicle such as from a manufacturer of vehicles (providing/establishing vehicle data, etc.) or a retailer/dealer for vehicles or to an owner/operator of the vehicle/vehicles; vehicle data may be managed with a security system; vehicle data with the article can be associated with the article and/or vehicle with the article by installation/placement in the compartment in the interior of the vehicle; vehicle data may be stored and/or transmitted separately from the vehicle; vehicle data may be stored and/to transmitted on or to/from a computing system/device, network device, mobile device (e.g. mobile phone, smart phone, mobile computing device, etc.). See also 16A-16J, 17A-b 17D, 18A-18F, 19A-19F and 20A-20G.

According to an exemplary embodiment as shown schematically in the FIGURES, a subassembly for a vehicle interior may comprise the component; the subassembly may comprise a module for the key fob and/or a key card; the component may provide a data interface. The data interface may be configured for interaction and/or connection with a scanner. The article containing data may be configured for data interchange. The article containing data may be configured for electronic data interchange. The article containing data may be configured for data interchange with a data interchange device. The data interchange device may comprise a sensor, a detector, a reader, a bar code reader, a scanner, a label scanner, and/or a code reader. The label may comprise a printed code, a bar code, a data code, a scannable code, a QR code, and/or a security code. The data interface may be configured for interaction and/or connection with a scanner. The component may comprise a label comprising data or information. The component may comprise a label comprising at least one of (a) a vehicle identification number; (b) a bar code; (c) a QR code, (d) a tag, (e) an RFID tag, (f) a data tag, (g) a transmitter. The component of Claim 1 further may comprise a label configured for at least one of (a) serializing the key fob to the vehicle; (b) tracking; (c) matching; (d) monitoring; (e) authenticating; (f) identification; (g) serialization; (h) communication; and/or (i) an instruction. The component may comprise a label; use by an occupant may comprise scanning the label.

### Exemplary Embodiments—B

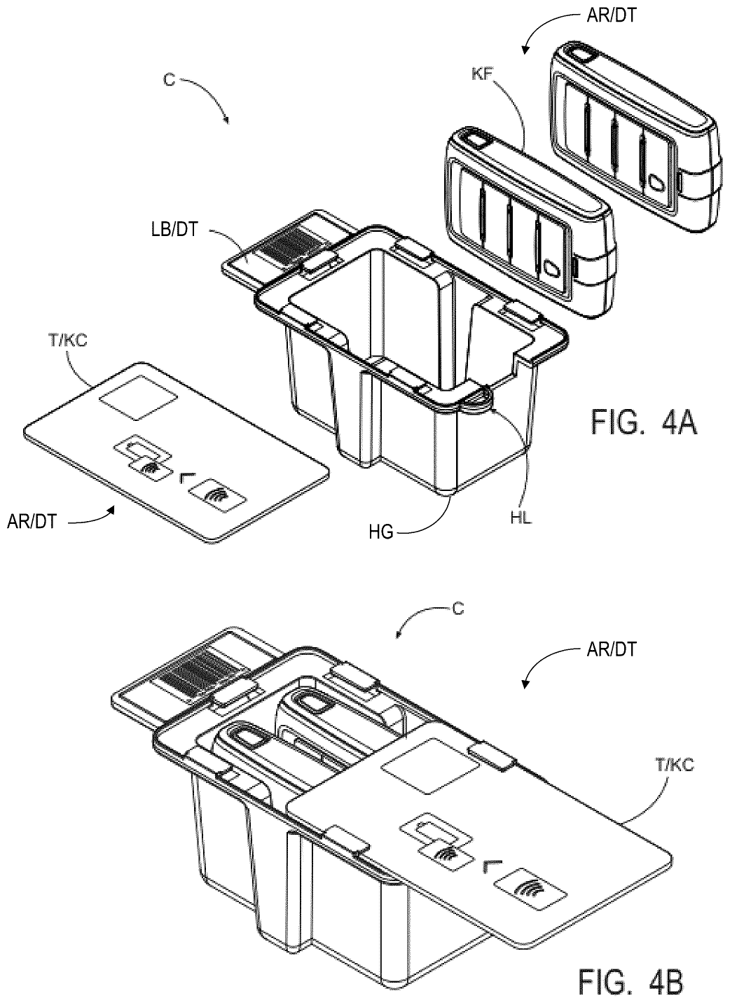

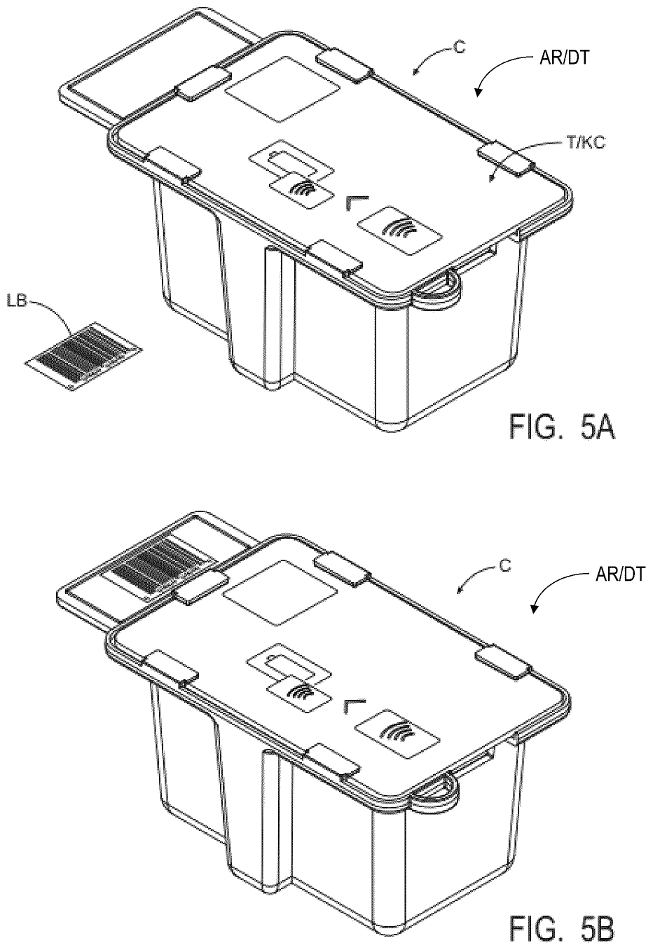

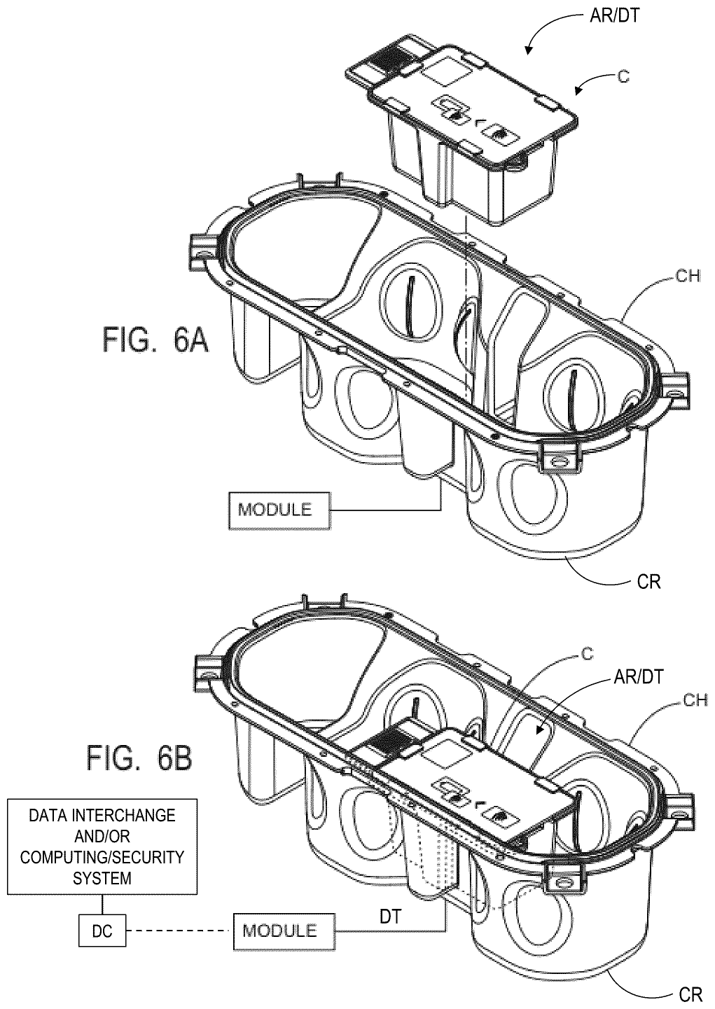

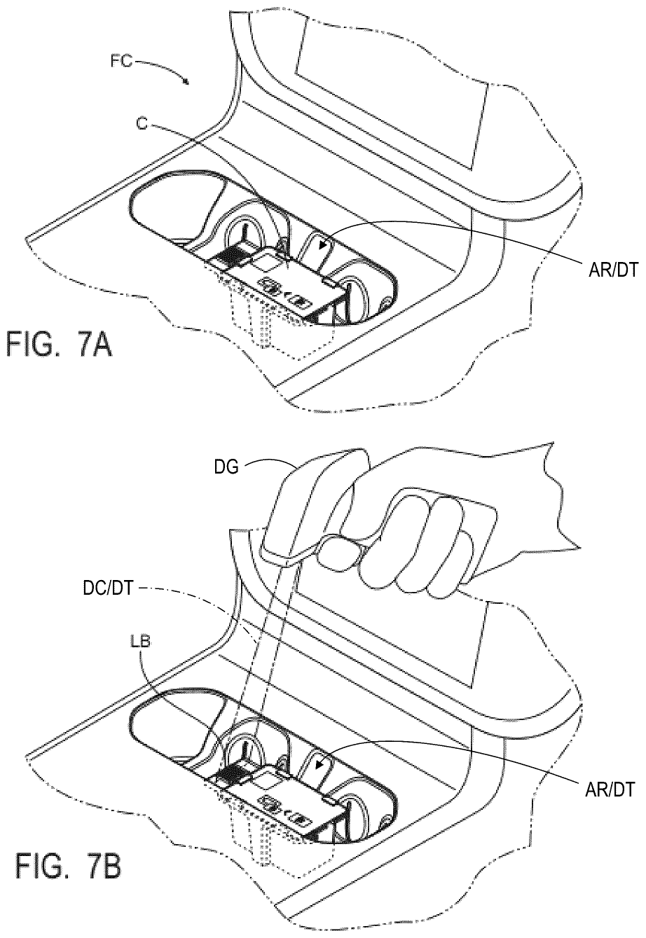

According to an exemplary embodiment as shown schematically in FIGS. 2, 3, 4A, 4B, 5A, 5B, 6A, 6B, 7A and 7B, a component C for use by an occupant in an interior of a vehicle may comprise a housing HG comprising a compartment. The compartment may be configured to receive a key fob KF for the vehicle. The component may be configured to be shipped together with the key fob and installed into the vehicle interior as a unit. The component may be configured to be removed by the occupant after installation into the vehicle interior. The component may be configured to be installed in the interior of the vehicle. The component may be removed from the interior of the vehicle for use by the occupant outside of the vehicle. The component may comprise a retention feature configured to retain the key fob. The component may be configured to retain a key card KC for the vehicle. The component may be configured to be shipped together with the key card and installed into the vehicle interior as a unit. The component may be configured to be removed by the occupant after installation into the vehicle interior. The component may comprise a retention feature configured to retain the key card. The retention feature may comprise an “L” shaped tab. The retention feature may comprise a set of tabs. The retention feature may comprise a set of tabs extending above the compartment. The retention feature may be configured to provide a gap through which the key card may slide for installation of the key card to the housing. The retention feature may be configured to clamp the key card to the housing. The key card may be configured to cover the compartment. (See FIGS. 2, 5A and 5B.) The key card may comprise a lid for the compartment. The key card may be configured to move between a closed position (as shown schematically in FIGS. 2, 5A, 5B, 6A, 6B, 7A and 7B) to cover the compartment and an open position (as shown schematically in FIG. 3) to uncover the compartment. (See FIG. 4B.) The key card may be configured to open, lock and or start the vehicle. The housing may comprise a tab. The tab may comprise a label LB. (See FIGS. 2, 3, 4A, 4B, 5B, 6A, 6B, 7A and 7B.) The component may comprise a hole (HL) configured for a ring. (See FIG. 8.) The component may comprise a tab comprising the hole as shown schematically in FIG. 4A. The component may provide a data interface. The data interface may be configured for interaction and/or connection with a scanner. (See FIG. 7B.) The component may comprise a label LB comprising data or information. The component may comprise a label LB comprising at least one of (a) a vehicle identification number; (b) a bar code; (c) a QR code, (d) a tag, (e) an RFID tag, (f) a data tag, (g) a transmitter. The component may comprise a label LB configured for at least one of (a) serializing the key fob to the vehicle; (b) tracking; (c) matching; (d) monitoring; (e) authenticating; (f) identification; (g) serialization; (h) communication; and/or (i) an instruction. (See FIG. 7B.) The component may comprise a label; use by an occupant may comprise scanning the label. (See FIG. 7B.) The housing may comprise an attachment feature configured to retain the housing in the interior of the vehicle. The attachment feature may comprise a protrusion extending away from the compartment. (See FIGS. 6A and 6B.) The component may be configured for installation in a subassembly for the vehicle interior. (See FIGS. 6A and 6B.) The subassembly for the vehicle interior may comprise at least one of (a) a cup holder; (b) a floor console; (c) a center console; (d) a door; (e) a cockpit; (f) an instrument panel. The component may be configured for at least one of a press-fit assembly to the subassembly and/or a snap-fit assembly to the subassembly. (See FIGS. 6A and 6B.) A subassembly for a vehicle interior may comprise the component. The subassembly may comprise a module for the key fob and/or a key card. (See FIGS. 6A and 6B.) The key fob may be configured to open, lock and or start the vehicle. The key fob may comprise a set of key fobs.

According to an exemplary embodiment as shown schematically in FIGS. 2, 3, 4A, 4B, 5A, 5B, 6A, 6B, 7A and 7B, a method of installing a key in a vehicle/vehicle interior may comprise the steps of installing the key in a component C and installing the component in a subassembly (shown schematically as a cup holder CH in FIGS. 6A and 6B) for the vehicle/vehicle interior. The key may comprise at least one of a key fob KF and/or a key card KC. The method may comprise the step of installing a module for the key to the subassembly for the vehicle interior. The method may comprise the step of scanning the module. The step of scanning the module may comprise at least one of (a) serializing the module to the vehicle; (b) tracking; (c) matching; (d) monitoring; (e) authenticating; (f) identification; (g) serialization; (h) communication; and/or (i) an instruction. The method may comprise the step of installing the subassembly for the vehicle interior in the vehicle interior. The component may comprise a housing HG comprising a compartment. The step of installing the key in a component may comprise placing the key in the compartment. The step of installing the key in a component may comprise snapping and/or pressing a key fob into the component. The step of installing the key in a component may comprise sliding a key card onto the component to provide a lid for a compartment. (See FIG. 4B.) The component may comprise a label LB. The method may comprise the step of scanning the label. (See FIG. 7B.) The step of scanning the label may comprise at least one of (a) serializing the key to the vehicle; (b) tracking; (c) matching; (d) monitoring; (e) authenticating; (f) identification; (g) serialization; (h) communication; and/or (i) an instruction. The label may comprise at least one of (a) a vehicle identification number, (b) a bar code, (c) a QR code, (d) a tag, (e) an RFID tag, (f) a data tag, (g) a transmitter. The subassembly for the vehicle interior may comprise at least one of (a) a cup holder; (b) a floor console; (c) a center console; (d) a door; (e) a cockpit; (f) an instrument panel.

### Exemplary Embodiments—C

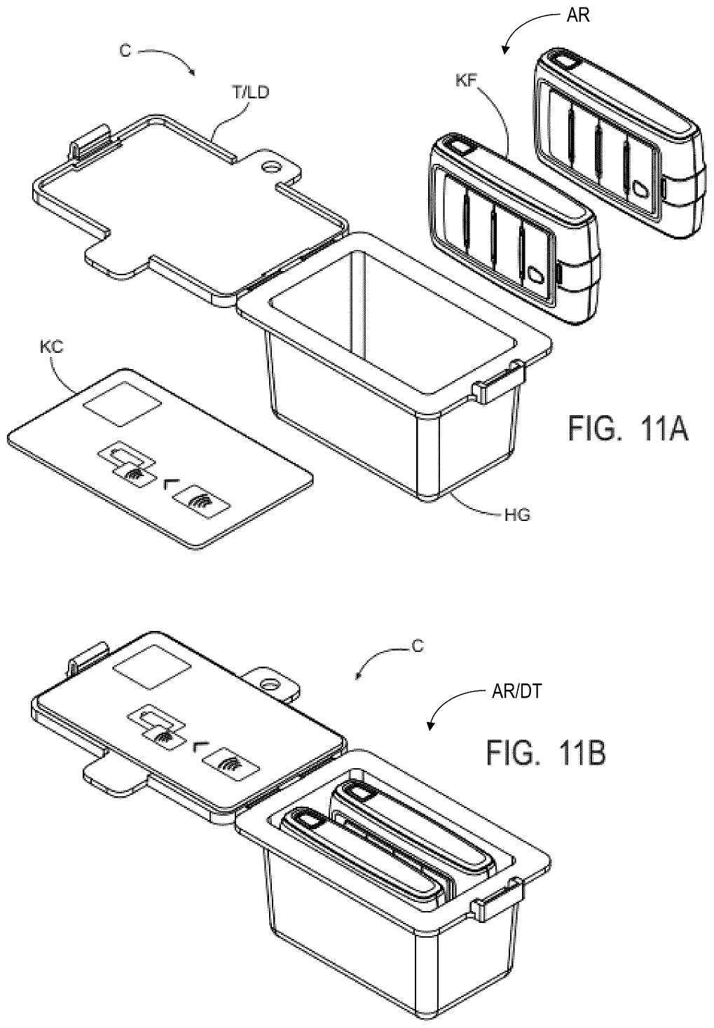

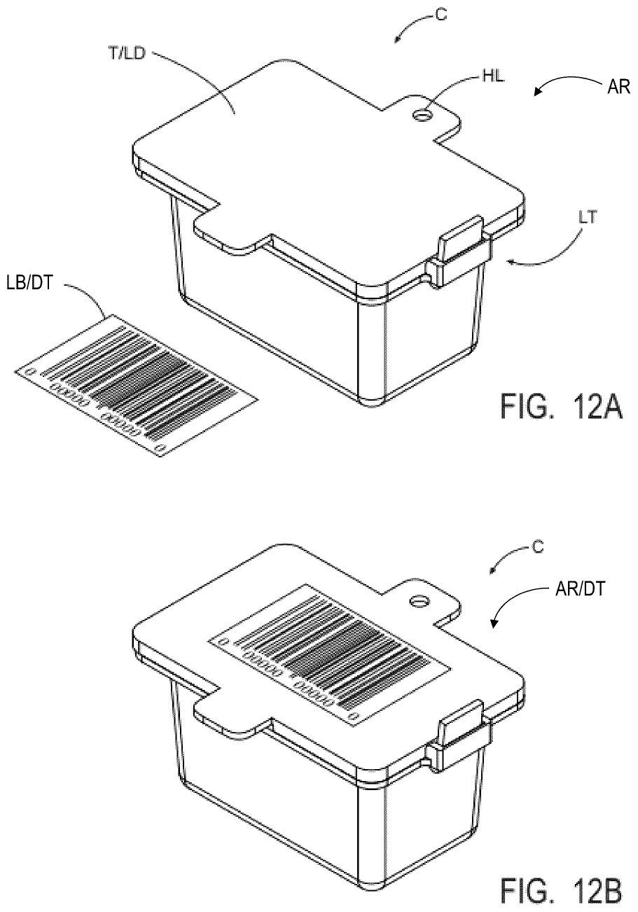

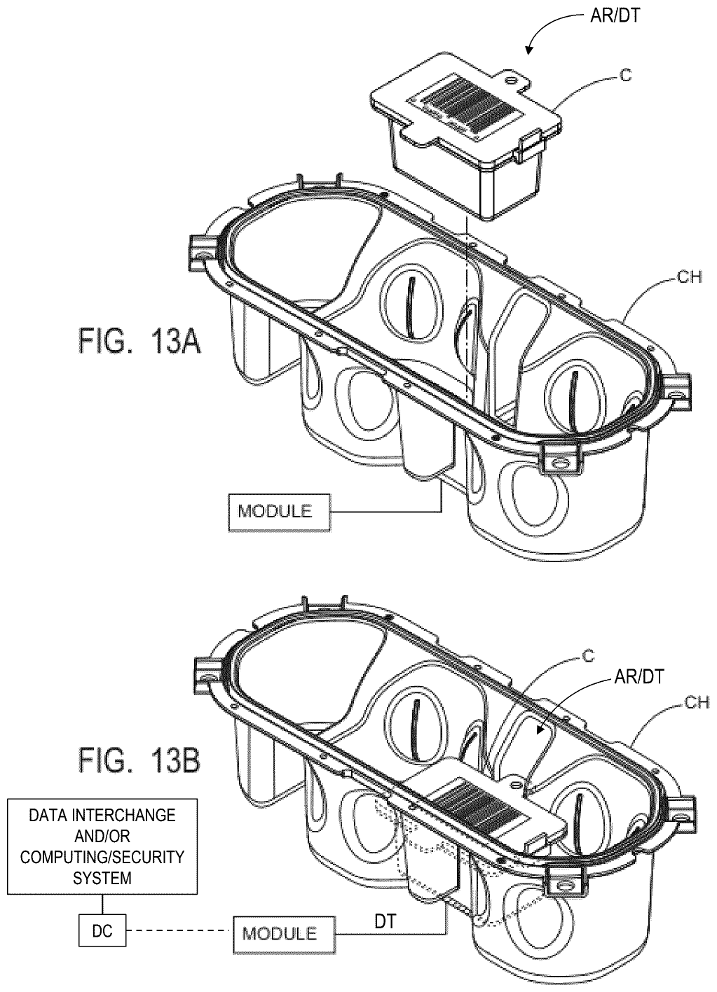

According to an exemplary embodiment as shown schematically in FIGS. 9, 10, 11A, 11B, 12A, 12B, 13A, 13B and 14A-14B, a component C for use by an occupant in an interior of a vehicle may comprise a housing HG comprising a compartment and a cover T configured to cover the compartment. The compartment may be configured to receive a key fob KF for the vehicle. The component may be configured to be shipped together with the key fob and installed into the vehicle interior as a unit. The component may be configured to be removed by the occupant after installation into the vehicle interior. The cover may be configured to move to an open position (as shown schematically in FIGS. 10, 11A and 11B) for access to the key fob. The component may be configured to be installed in the interior of the vehicle. The component may be configured to be removed from the interior of the vehicle for use by the occupant outside of the vehicle. The component may comprise a retention feature configured to retain the key fob. The component may be configured to retain a key card KC for the vehicle. The component may be configured to be shipped together with the key card and installed into the vehicle interior as a unit. The component may comprise a retention feature configured to retain the key card. The cover may comprise a lid LD. The component may comprise a hinge for the cover. The cover may be configured to move between a closed position (as shown schematically in FIGS. 9, 12A, 12B, 13A, 13B, 14A and 14B) to cover the compartment and an open position (as shown schematically in FIGS. 10, 11A and 11B) to uncover the compartment. The cover may comprise a top side. The top side of the cover may comprise a label LB. The cover may comprise a bottom side facing the compartment. The bottom side of the cover may comprise a key card KC for the vehicle. The bottom side of the cover may comprise a retention feature configured to retain a key card KC for the vehicle. (See FIG. 11B.) The component may comprise a hole HL configured for a ring. The cover may comprise a tab comprising the hole. The component may comprise a latch LT configured to retain the cover to the housing. (See FIG. 12A.) The component may provide a data interface. The data interface may be configured for interaction and/or connection with a scanner. (See FIG. 14B.) The component may comprise a label LB comprising data or information. The component may comprise a label LB comprising at least one of (a) a vehicle identification number, (b) a bar code, (c) a QR code, (d) a tag, (e) an RFID tag, (f) a data tag, (g) a transmitter. The component may comprise a label LB configured for at least one of (a) serializing the key fob to the vehicle, (b) tracking, (c) matching, (d) monitoring, (e) authenticating, (f) identification, (g) serialization, (h) communication, and/or (i) an instruction. (See FIG. 14B.) The component may comprise a label LB; use by an occupant may comprise scanning the label. (See FIG. 14B.) The housing may comprise an attachment feature configured to retain the housing in the interior of the vehicle. The component may be configured for installation in a subassembly for the vehicle interior. (See FIGS. 13A and 13B.) The subassembly for the vehicle interior may comprise at least one of (a) a cup holder, (b) a floor console, (c) a center console, (d) a door, (e) a cockpit, (f) an instrument panel. A subassembly for the vehicle interior may comprise the component. The subassembly may comprise a module for the key fob. The key fob may comprise a set of key fobs as shown schematically in FIGS. 10 and 11B.

According to an exemplary embodiment as shown schematically in the FIGURES, a method of installing a key in a vehicle interior may comprise the steps of installing the key in a component C and installing the component in a subassembly for the vehicle interior. The key may comprise at least one of a key fob KF and/or a key card KC. The method may comprise the step of installing a module for the key to the subassembly for the vehicle interior. The method may comprise the step of installing the subassembly for the vehicle interior in the vehicle interior. The component may comprise a housing HG comprising a compartment and a cover T configured to cover the compartment. The step of installing the key in a component may comprise placing the key in the compartment. The step of installing the key in a component may comprise snapping the key onto the cover. The component may comprise a label LB. The method may comprise the step of scanning the label.

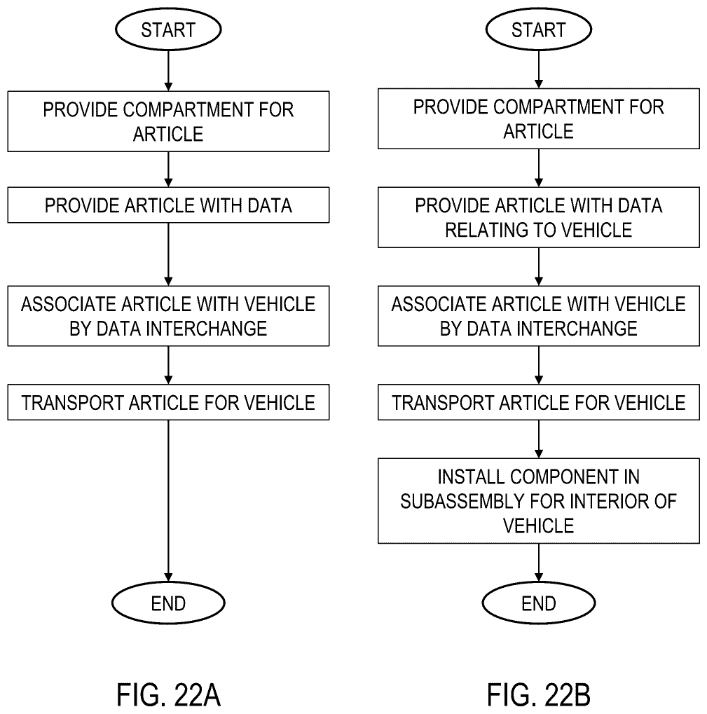

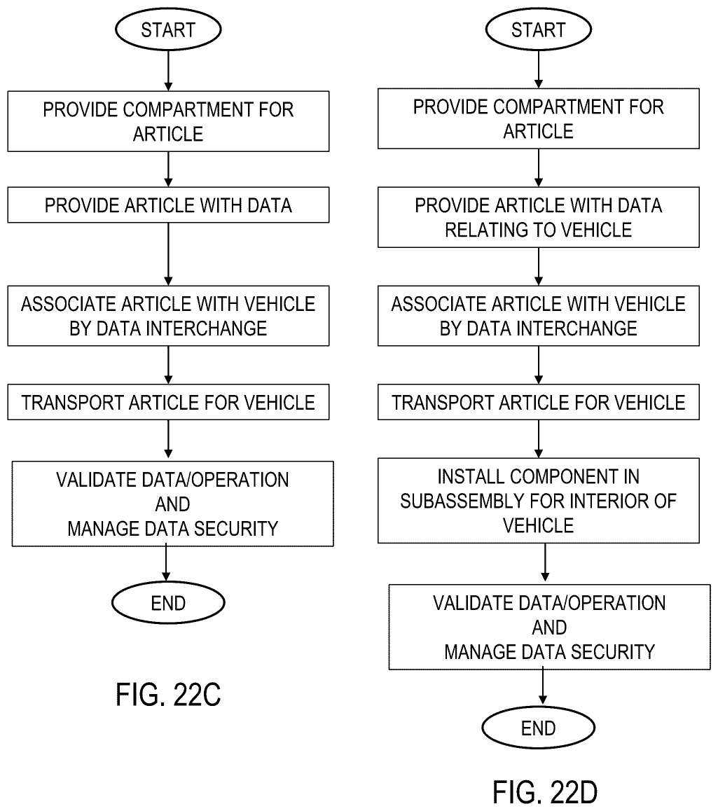

According to an exemplary embodiment as indicated schematically in FIGS. 22A-22D, the system may be provided for the vehicle according to a method, including validation of data/operation and management of data security. According to an exemplary embodiment as shown schematically in FIG. 22A, a method of manufacturing/assembling a component may comprise providing a compartment for the article in the interior of the vehicle, providing the article with data relating to the vehicle, associating the article with the vehicle by data interchange, and transporting the article for the vehicle. According to an exemplary embodiment as shown schematically in FIG. 22B, a method of manufacturing/assembling a component may comprise providing a compartment for the article in the interior of the vehicle, providing the article with data relating to the vehicle, associating the article with the vehicle by data interchange, transporting the article for the vehicle, and installing the component in a subassembly for the vehicle interior.

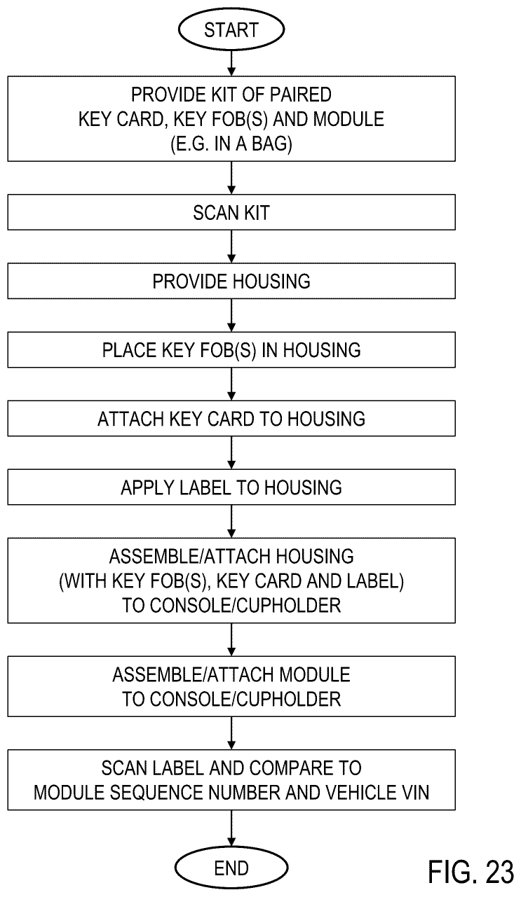

According to an exemplary embodiment as shown schematically in FIG. 23, a method of manufacturing/assembling a component for use by an occupant in an interior of a vehicle may comprise providing a kit of a paired key card, key fob(s) and/or a module (e.g. in a bag), scanning the kit, providing a housing, placing the key fob(s) in the housing, attaching the key card to the housing, applying a label to the housing, assembling/attaching the housing (with key fob(s), key card and label) to a console/cupholder, assembling/attaching a module to the console/cupholder, scanning the label, and comparing the label to a module sequence number and/or a vehicle identification number (VIN).

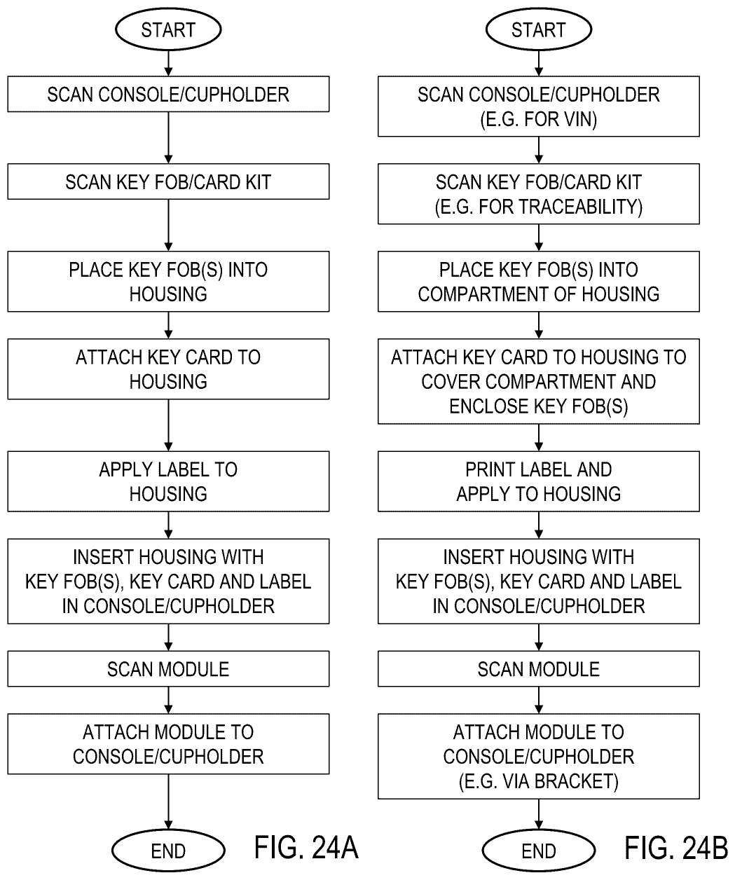

According to an exemplary embodiment as shown schematically in FIG. 24A, a method of manufacturing/assembling a component for use by an occupant in an interior of a vehicle may comprise scanning a console/cupholder, scanning a key fob/card kit, placing key fob(s) into a housing, attaching a key card to the housing, applying a label to the housing, inserting the housing with key fob(s), key card and label in the console/cupholder, scanning a module, and attaching the module to the console/cupholder.

According to an exemplary embodiment as shown schematically in FIG. 24B, a method of manufacturing/assembling a component for use by an occupant in an interior of a vehicle may comprise scanning a console/cupholder (e.g. for a VIN), scanning a key fob/card kit (e.g. for traceability), placing key fob(s) into a compartment of a housing, attaching a key card to the housing to cover the compartment and enclose the key fob(s), printing a label and applying the label to the housing, inserting the housing with the key fob(s), key card and label in the console/cupholder, scanning a module, and attaching the module to the console/cupholder (e.g. via a bracket).

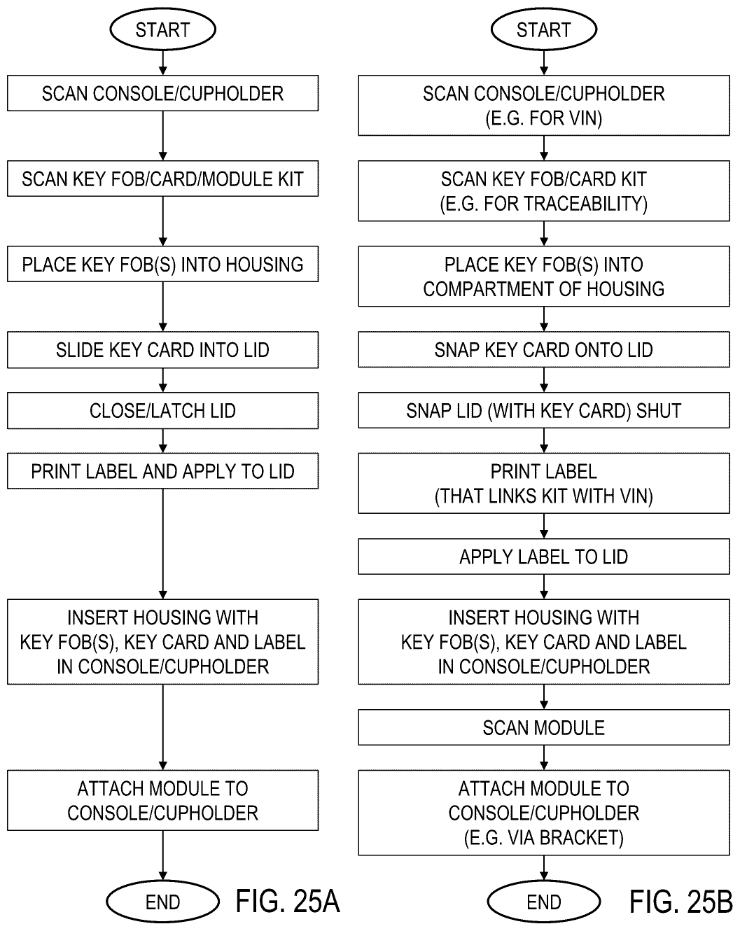

According to an exemplary embodiment as shown schematically in FIG. 25A, a method of manufacturing/assembling a component for use by an occupant in an interior of a vehicle may comprise scanning a console/cupholder, scanning a key fob/card/module kit, placing a key fob(s) into a housing, sliding a key card into a lid of the housing, closing/latching the lid, printing a label and applying it to the housing/lid, inserting the housing with key fob(s), key card and label in the console/cupholder, and attaching a module to the console/cupholder.

According to an exemplary embodiment as shown schematically in FIG. 25B, a method of manufacturing/assembling a component for use by an occupant in an interior of a vehicle may comprise scanning console/cupholder (e.g. for VIN), scanning a key fob/card kit (e.g. for traceability), placing the key fob(s) into a compartment of a housing, snapping a key card onto a lid of the housing, snapping the lid (with key card) shut, printing a label (that links the kit with a VIN), applying a label to the lid, inserting the housing with the key fob(s), key card and label in the console/cupholder, scanning the module, and attaching the module to the console/cupholder (e.g. via a bracket).

### Exemplary Embodiments—D

As indicated schematically in FIGS. 16A-16J, 17A-17D, 18A-18F, 19A-19F and 20A-20G and 21, the system with network/devices may be configured to facilitate the article with vehicle data and/or the article to be transported/transmitted separately from the vehicle and/or for the article with vehicle data to be transported with the vehicle, such as from a manufacturer of vehicles (providing/establishing vehicle data, etc.) or a retailer/dealer for vehicles or to an owner/operator of the vehicle/vehicles. The component for the system may provide a data interface. The data interface may be configured for interaction and/or connection with a scanner. The component may comprise a label comprising data or information. The component may comprise a label comprising at least one of (a) a vehicle identification number; (b) a bar code; (c) a QR code, (d) a tag, (e) an RFID tag, (f) a data tag, (g) a transmitter. The component may comprise a label configured for at least one of (a) serializing the key fob to the vehicle; (b) tracking; (c) matching; (d) monitoring; (e) authenticating; (f) identification; (g) serialization; (h) communication; and/or (i) an instruction.

According to an exemplary embodiment as shown schematically in FIG. 23, a method of manufacturing/assembling a component for use by an occupant in an interior of a vehicle may comprise providing a kit of a paired key card, key fob(s) and/or a module (e.g. in a bag), scanning the kit, providing a housing, placing the key fob(s) in the housing, attaching the key card to the housing, applying a label to the housing, assembling/attaching the housing (with key fob(s), key card and label) to a console/cupholder, assembling/attaching a module to the console/cupholder, scanning the label, and comparing the label to a module sequence number and/or a vehicle identification number (VIN).

According to an exemplary embodiment as shown schematically in FIG. 24A, a method of manufacturing/assembling a component for use by an occupant in an interior of a vehicle may comprise scanning a console/cupholder, scanning a key fob/card kit, placing key fob(s) into a housing, attaching a key card to the housing, applying a label to the housing, inserting the housing with key fob(s), key card and label in the console/cupholder, scanning a module, and attaching the module to the console/cupholder.

According to an exemplary embodiment as shown schematically in FIG. 24B, a method of manufacturing/assembling a component for use by an occupant in an interior of a vehicle may comprise scanning a console/cupholder (e.g. for a VIN), scanning a key fob/card kit (e.g. for traceability), placing key fob(s) into a compartment of a housing, attaching a key card to the housing to cover the compartment and enclose the key fob(s), printing a label and applying the label to the housing, inserting the housing with the key fob(s), key card and label in the console/cupholder, scanning a module, and attaching the module to the console/cupholder (e.g. via a bracket).

According to an exemplary embodiment as shown schematically in FIG. 25A, a method of manufacturing/assembling a component for use by an occupant in an interior of a vehicle may comprise scanning a console/cupholder, scanning a key fob/card/module kit, placing a key fob(s) into a housing, sliding a key card into a lid of the housing, closing/latching the lid, printing a label and applying it to the housing/lid, inserting the housing with key fob(s), key card and label in the console/cupholder, and attaching a module to the console/cupholder.

According to an exemplary embodiment as shown schematically in FIG. 25B, a method of manufacturing/assembling a component for use by an occupant in an interior of a vehicle may comprise scanning console/cupholder (e.g. for VIN), scanning a key fob/card kit (e.g. for traceability), placing the key fob(s) into a compartment of a housing, snapping a key card onto a lid of the housing, snapping the lid (with key card) shut, printing a label (that links the kit with a VIN), applying a label to the lid, inserting the housing with the key fob(s), key card and label in the console/cupholder, scanning the module, and attaching the module to the console/cupholder (e.g. via a bracket).

TABLE A
REFERENCE SYMBOL LIST

| REFERENCE SYMBOL | ELEMENT, PART OR COMPONENT |
|---|---|
| V | Vehicle |
| I | Interior |
| FC | Console (e.g. floor console) |
| C | Component |
| AR | Article (e.g. item/device configured to contain/ |
| | carry data) |
| DT | Data/information (e.g. data-containing item/ |
| | device, such as for vehicle/vehicle-related |
| | information) |
| DC | Data communication/interface |
| DG | Data interchange device (e.g. scanner, reader, |
| | interface, transmitter, receiver, etc.) |
| KF | Key fob |
| KC | Card (e.g. data card, key card, etc.) |
| CR | Compartment/container for article/data |
| T | Cover |
| LD | Lid |
| HG | Housing |
| HL | Hole |
| LT | Latch |
| LB | Label |
| CH | Container (e.g. holder, cup holder, bin, etc.) |
| MODULE | Device/module for data communication/ |
| | interchange |

It is important to note that the present inventions (e.g. inventive concepts, etc.) have been described in the specification and/or illustrated in the FIGURES of the present patent document according to exemplary embodiments; the embodiments of the present inventions are presented by way of example only and are not intended as a limitation on the scope of the present inventions. The construction and/or arrangement of the elements of the inventive concepts embodied in the present inventions as described in the specification and/or illustrated in the FIGURES is illustrative only. Although exemplary embodiments of the present inventions have been described in detail in the present patent document, a person of ordinary skill in the art will readily appreciate that equivalents, modifications, variations, etc. of the subject matter of the exemplary embodiments and alternative embodiments are possible and contemplated as being within the scope of the present inventions; all such subject matter (e.g. modifications, variations, embodiments, combinations, equivalents, etc.) is intended to be included within the scope of the present inventions. It should also be noted that various/other modifications, variations, substitutions, equivalents, changes, omissions, etc. may be made in the configuration and/or arrangement of the exemplary embodiments (e.g. in concept, design, structure, apparatus, form, assembly, construction, means, function, system, process/method, steps, sequence of process/method steps, operation, operating conditions, performance, materials, composition, combination, etc.) without departing from the scope of the present inventions; all such subject matter (e.g. modifications, variations, embodiments, combinations, equivalents, etc.) is intended to be included within the scope of the present inventions. The scope of the present inventions is not intended to be limited to the subject matter (e.g. details, structure, functions, materials, acts, steps, sequence, system, result, etc.) described in the specification and/or illustrated in the FIGURES of the present patent document. It is contemplated that the claims of the present patent document will be construed properly to cover the complete scope of the subject matter of the present inventions (e.g. including any and all such modifications, variations, embodiments, combinations, equivalents, etc.); it is to be understood that the terminology used in the present patent document is for the purpose of providing a description of the subject matter of the exemplary embodiments rather than as a limitation on the scope of the present inventions.

It is also important to note that according to exemplary embodiments the present inventions may comprise conventional technology (e.g. as implemented and/or integrated in exemplary embodiments, modifications, variations, combinations, equivalents, etc.) or may comprise any other applicable technology (present and/or future) with suitability and/or capability to perform the functions and processes/operations described in the specification and/or illustrated in the FIGURES. All such technology (e.g. as implemented in embodiments, modifications, variations, combinations, equivalents, etc.) is considered to be within the scope of the present inventions of the present patent document.

The invention claimed is:

1. A component for an interior of a vehicle configured to contain an article containing data for the vehicle comprising:
a housing comprising a compartment;
wherein the compartment is configured to contain the article.

2. The component of claim 1 comprising a feature configured to retain the article in the housing.

3. The component of claim 2 wherein the article comprises at least one of (a) a key; (b) an electronic key unit; (c) a card; (d) a card containing data; (e) a key card; (f) a fob; (g) a key fob; (h) a label; (i) a tag; (j) a data tag; (k) and electronic tag; (l) a detectable tag; (m) a scannable tag; (n) a scannable label; (o) a code; (p) a readable code; (q) a tag configured for data interchange with a data interchange device; (r) a tag configured for data interchange to a computing device; (s) a tag configured for data interchange to a mobile device.

4. The component of claim 3 wherein the feature is configured to provide a receptacle for a key card; so that the key card is configured to be retained in the housing.

5. The component of claim 4 wherein the feature comprises a retention feature comprising a L-shaped tab provided on the housing.

6. The component of claim 3 wherein the feature is configured to provide a slot for a key card; wherein the slot comprises a gap; wherein the key card is configured to be inserted into the gap of the slot for installation in the housing.

7. The component of claim 3 wherein the feature is configured to clamp a key card to the housing.

8. The component of claim 1 wherein the article comprises a key card; wherein the key card is configured to provide a cover for the housing; wherein the key card can be moved between a position to cover the compartment and a position to uncover the compartment.

9. The component of claim 1 wherein the housing comprises a projection.

10. The component of claim 9 wherein the projection comprises a tab; wherein the tab comprises a label; wherein the label is configured to comprise data and/or information.

11. The component of claim 9 wherein the projection comprises a tab; wherein the tab comprises a hole configured for a ring.

12. The component of claim 1 wherein the housing comprises an attachment feature configured to retain the housing in the interior of the vehicle; wherein the attachment feature comprises a projection.

13. The component of claim 1 further comprising a subassembly comprising the housing; wherein the subassembly is configured for installation in the interior of the vehicle.

14. The component of claim 13 wherein the housing is configured for installation in the subassembly by at least one of press-fit assembly and/or snap-fit assembly.

15. The component of claim 13 wherein the subassembly comprises at least one of (a) a cup holder; (b) a floor console; (c) a center console; (d) a door; (e) a cockpit; (f) an instrument panel; (g) a module for the article within the compartment.

16. The component of claim 1 wherein the article containing data is configured for electronic data interchange and/or wireless data interchange.

17. The component of claim 1 wherein the article containing data is configured for data interchange with a data interchange device.

18. The component of claim 1 wherein the article containing data comprises a tag containing data; wherein data from the tag is configured for data interchange; wherein the tag comprises at least one of (a) an electronic tag configured for electronic/wireless data interchange and/or (b) a label configured to be detected by a data interchange device.

19. The component of claim 18 wherein the tag comprises an electronic tag for the article and/or a label on the article.

20. A method of providing interchange of data for a vehicle with a component for an interior of the vehicle configured to contain an article containing data for the vehicle comprising the steps of:
(a) providing a compartment for the article in the interior of the vehicle;
(b) providing the article with data relating to the vehicle;
(c) associating the article with the vehicle by data interchange;
(d) transporting the article for the vehicle;
wherein transporting the article comprises at least one of (a) transporting the article in the compartment of the vehicle or (b) transporting the article with the vehicle or (c) transporting the article separately from the vehicle or (d) transporting the article separately from the compartment;
wherein the article comprises at least one of (a) a key; (b) an electronic key unit; (c) a card; (d) a card containing data; (e) a key card; (f) a fob; (g) a key fob; (h) a label; (i) a tag; (j) a data tag; (k) and electronic tag; (l) a detectable tag; (m) a scannable tag; (n) a scannable label; (o) a code; (p) a readable code; (q) a tag configured for data interchange with a data interchange device; (r) a tag configured for data interchange to a computing device; (s) a tag configured for data interchange to a mobile device; (t) a tag configured to provide a data interface;
wherein data comprises at least one of (a) vehicle data; (b) vehicle identification data; (c) vehicle identification number (VIN); (d) security data; (e) vehicle access data; (f) vehicle access data; (g) vehicle key data; (h) a bar code; (i) a QR code; (j) a tag; (k) an RFID tag; (l) a data tag; (m) scannable data; (n) visual data; (o) electronic data;
wherein data interchange comprises at least one of (a) data interchange for the vehicle; (b) data interchange for access to the vehicle; (c) data interchange for operation of the vehicle (d) data interchange for transmission to the vehicle; (e) data interchange for transmission from the vehicle; (f) associating the article for the vehicle; (g) associating a key unit with the vehicle; (h) associating a key fob with the vehicle; (i) tracking; (j) matching; (k) monitoring; (l) authenticating; (m) identification; (n) serialization; (o) communication; and/or (p) an instruction.
